(19) United States
(12) Patent Application Publication
(10) Pub. No.: US 2023/0200430 A1
(43) Pub. Date: Jun. 29, 2023

(54) ORAL PRODUCTS WITH HIGH-DENSITY LOAD

(71) Applicant: NICOVENTURES TRADING LIMITED, London (GB)

(72) Inventors: Kasper H. Jensen, Hellerup (DK); Ronald K. Hutchens, East Bend, NC (US); Alexandre Mendes Campos, Winston-Salem, NC (US); Christopher Keller, Advance, NC (US); Travis O'Neal, Pinnacle, NC (US); Matthew D. Sain, Mocksville, NC (US); Darrell Vian, Winston-Salem, NC (US); Lorenzo Uberti, London (GB); Jared Aller, Winston-Salem, NC (US); Christina Tapp, Walnut Creek, CA (US); Vic Pramono, Campbell, CA (US)

(21) Appl. No.: 18/110,221

(22) Filed: Feb. 15, 2023

Related U.S. Application Data
(63) Continuation-in-part of application No. 17/733,187, filed on Apr. 29, 2022.
(60) Provisional application No. 63/182,319, filed on Apr. 30, 2021.

(51) Int. Cl. A24B 13/00; A24B 15/16

(52) U.S. Cl. CPC A24B 13/00; A24B 15/16; B23K 26/36

(57) ABSTRACT

The disclosure provides methods of preparing pouched products which includes the production of an agglomerated composition situated with a cavity of an outer water-permeable pouch. The pouched agglomerate can be dosed with a given amount of moisture, resulting in at least partial degradation and/or expansion of the agglomerated composition into powdered form. Pouched products prepared according to such methods are also described.

### CROSS-REFERENCE TO RELATED APPLICATIONS

This application is a continuation-in-part of U.S. patent application Ser. No. 17/733,187, filed Apr. 29, 2022, which claims priority to U.S. Provisional Application No. 63/182,319, filed on Apr. 30, 2021. The disclosures of both applications are incorporated herein by reference in their entireties and for all purposes.

### FIELD OF THE DISCLOSURE

The present disclosure relates to pouched products containing compositions intended for human use. The products are configured for oral use and deliver substances such as flavors and/or active ingredients during use. Such products may include tobacco or a product derived from tobacco, or may be tobacco-free alternatives.

### BACKGROUND

Tobacco may be enjoyed in a so-called “smokeless” form. Particularly popular smokeless tobacco products are employed by inserting some form of processed tobacco or tobacco-containing formulation into the mouth of the user. Conventional formats for such smokeless tobacco products include moist snuff, snus, and chewing tobacco, which are typically formed almost entirely of particulate, granular, or shredded tobacco, and which are either portioned by the user or presented to the user in individual portions, such as in single-use pouches or sachets. Other traditional forms of smokeless products include compressed or agglomerated forms, such as plugs, tablets, or pellets. Alternative product formats, such as tobacco-containing gums and mixtures of tobacco with other plant materials, are also known. See for example, the types of smokeless tobacco formulations, ingredients, and processing methodologies set forth in U.S. Pat. No. 1,376,586 to Schwartz; U.S. Pat. No. 4,513,756 to Pittman et al.; U.S. Pat. No. 4,528,993 to Sensabaugh, Jr. et al.; U.S. Pat. No. 4,624,269 to Story et al.; U.S. Pat. No. 4,991,599 to Tibbetts; U.S. Pat. No. 4,987,907 to Townsend; U.S. Pat. No. 5,092,352 to Sprinkle, III et al.; U.S. Pat. No. 5,387,416 to White et al.; U.S. Pat. No. 6,668,839 to Williams; U.S. Pat. No. 6,834,654 to Williams; U.S. Pat. No. 6,953,040 to Atchley et al.; U.S. Pat. No. 7,032,601 to Atchley et al.; and U.S. Pat. No. 7,694,686 to Atchley et al.; US Pat. Pub. Nos. 2004/0020503 to Williams; 2005/0115580 to Quinter et al.; 2006/0191548 to Strickland et al.; 2007/0062549 to Holton, Jr. et al.; 2007/0186941 to Holton, Jr. et al.; 2007/0186942 to Strickland et al.; 2008/0029110 to Dube et al.; 2008/0029116 to Robinson et al.; 2008/0173317 to Robinson et al.; 2008/0209586 to Neilsen et al.; 2009/0065013 to Essen et al.; and 2010/0282267 to Atchley, as well as WO2004/095959 to Arnarp et al., each of which is incorporated herein by reference.

Smokeless tobacco product configurations that combine tobacco material with various binders and fillers have been proposed more recently, with example product formats including lozenges, pastilles, gels, extruded forms, and the like. See, for example, the types of products described in US Patent App. Pub. Nos. 2008/0196730 to Engstrom et al.; 2008/0305216 to Crawford et al.; 2009/0293889 to Kumar et al.; 2010/0291245 to Gao et al; 2011/0139164 to Mua et al.; 2012/0037175 to Cantrell et al.; 2012/0055494 to Hunt et al.; 2012/0138073 to Cantrell et al.; 2012/0138074 to Cantrell et al.; 2013/0074855 to Holton, Jr.; 2013/0074856 to Holton, Jr.; 2013/0152953 to Mua et al.; 2013/0274296 to Jackson et al.; 2015/0068545 to Moldoveanu et al.; 2015/0101627 to Marshall et al.; and 2015/0230515 to Lampe et al., each of which is incorporated herein by reference. Oral products in similar formats and which are free of tobacco have also been proposed.

There is a continuing need in the art to develop product formats for oral compositions that enhance the sensory experience of the consumer.

### BRIEF SUMMARY

The present disclosure generally provides a composition enclosed in a pouch to form a pouched product configured for oral use. The composition is loaded within the pouch at a density of about 0.45 g/cm³ or higher, allowing more of the composition by weight to occupy the pouch volume. Accordingly, in one aspect, the disclosure provides a composition enclosed in a pouch to form a pouched product configured for oral use, wherein the composition is loaded within the pouch at a density of about 0.45 g/cm³ or higher, the composition comprising: a filler in an amount of at least 20% by weight, based on the total weight of the composition; and at least one active ingredient, at least one flavorant, or both at least one active ingredient and at least one flavorant.

In some embodiments, the composition is loaded within the pouch at a density from about 0.45 g/cm³ to about 2 g/cm³, or from about 0.5 g/cm³ to about 1.5 g/cm³.

In some embodiments, the pouch has a length, a width, and a thickness, wherein each of said length, width, and thickness are in a range from about 0.1 mm to about 40 mm.

In some embodiments, the composition is in the form of a particulate material, a compressed tablet, or a compressed pellet.

In some embodiments, the filler comprises or is microcrystalline cellulose.

In some embodiments, the composition further comprises a cellulose derivative.

In some embodiments, the composition further comprises a salt and at least one sweetener. In some embodiments, the salt is sodium chloride, ammonium chloride, or a combination thereof.

In some embodiments, the composition comprises at least one flavorant.

In some embodiments, the active ingredient comprises one or more botanical materials, one or more stimulants, one or more amino acids, one or more vitamins, one or more antioxidants, one or more cannabinoids, one or more cannabimimetics, one or more terpenes, one or more pharmaceutical agents, or a combination thereof.

In some embodiments, the active ingredient is a stimulant. In some embodiments, the stimulant is caffeine, theanine, or a combination thereof.

In some embodiments, the composition further comprises one or more vitamins, one or more amino acids, or a combination thereof, as an additional active ingredient. In some embodiments, the one or more vitamins is B6, B12, or a combination thereof.

In some embodiments, the one or more amino acids is taurine.

In some embodiments, the composition further comprises an alginate.

In some embodiments, the active ingredient comprises caffeine.

In some embodiments, the active ingredient comprises theanine.

In some embodiments, the active ingredient comprises taurine.

In some embodiments, the active ingredient comprises GABA.

In some embodiments, the active ingredient comprises tryptophan.

In some embodiments, the active ingredient comprises vitamin B6, vitamin B12, or both.

In some embodiments, the active ingredient comprises vitamin C.

In some embodiments, the active ingredient comprises ginseng.

In some embodiments, the active ingredient comprises lemon balm extract.

In some embodiments, the active ingredient comprises a combination of theanine and gamma-aminobutyric acid. In some embodiments, the active ingredient comprises a combination of theanine, gamma-aminobutyric acid, and lemon balm extract.

In some embodiments, the active ingredient comprises theanine and tryptophan. In some embodiments, the active ingredient comprises theanine and vitamin B6, B12, or a combination thereof. In some embodiments, the active ingredient comprises theanine, tryptophan, and vitamin B6, B12, or a combination thereof, such as vitamins B6 and B12 in a total amount by weight from about 0.008% to about 0.07%.

In some embodiments, the active ingredient comprises theanine, theanine and tryptophan, or theanine and one or more of vitamins B6 and B12, and optionally tryptophan.

In some embodiments, the active ingredient comprises a combination of caffeine, taurine, and Vitamin C.

In some embodiments, the active ingredient comprises a combination of caffeine, theanine, and ginseng. In some embodiments, the active ingredient comprises a combination of caffeine, theanine, ginseng, and citicoline.

In some embodiments, the active ingredient is bleached.

In some embodiments, the active ingredient comprises a nicotine component.

In some embodiments, the composition is substantially free of nicotine.

In some embodiments, the active ingredient comprises a cannabionoid.

In some embodiments, the composition is substantially free of tobacco.

In some embodiments, the composition further comprises one or more organic acids, alkali metal salts of an organic acid, or a combination thereof. In some embodiments, the alkali metal is sodium or potassium. In some embodiments, the one or more organic acids is an alkyl carboxylic acid, an aryl carboxylic acid, or a combination of any thereof. In some embodiments, the composition comprises an organic acid and a sodium salt of the organic acid. In some embodiments, the organic acid has a log P value of from about 1.4 to about 8.0, from about 1.4 to about 4.5, from about 2.5 to about 3.5, or from about 4.5 to about 8.0. In some embodiments, the one or more organic acids is citric acid, malic acid, tartaric acid, octanoic acid, benzoic acid, a toluic acid, salicylic acid, or a combination thereof.

In some embodiments, the one or more organic acids is present in the composition in an amount by weight of from about 0.1 to about 10%, based on the total weight of the composition. In some embodiments, the one or more organic acids is present in the composition in an amount by weight of from about 0.1 to about 0.5%, based on the total weight of the composition.

In some embodiments, the composition further comprises magnesium, such as magnesium in an amount by weight from about 0.1% to about 2%, or from about 0.2 to about 1%, based on elemental magnesium. In some embodiments, the magnesium is in the form of a magnesium salt. In some embodiments, the magnesium salt is magnesium gluconate.

In another aspect is provided a method of making a pouched product configured for oral use comprising a composition enclosed in a pouch, wherein the composition is loaded within the pouch at a density of at least about 0.45 g/cm³, the composition comprising a filler in an amount of at least 20% by weight, based on the total weight of the composition, at least one active ingredient, at least one flavorant, or both at least one active ingredient and at least one flavorant, the method comprising: blending the filler, the at least one active ingredient, the at least one flavorant, or both to form the composition; and enclosing the composition in the pouch to form the pouched product.

In some embodiments, the pouch has a length, a width, and a thickness, wherein each of said length, width, and thickness are in a range from about 0.1 mm to about 40 mm.

In some embodiments, the composition is loaded within the pouch at a density from about 0.45 g/cm³ to about 2 g/cm³, or from about 0.5 g/cm³ to about 1.5 g/cm³.

In some embodiments, the composition is loaded within the pouch using vacuum filling.

In some embodiments, the method comprises increasing the density of the composition prior to enclosing in the pouch. In some embodiments, increasing the density of the composition comprises one or more of decreasing an average particle size of the composition, increasing a moisture level of the composition, and compressing the composition.

In some embodiments, increasing the density of the composition comprises compressing the composition into a predetermined shape, wherein the predetermined shape is a pellet or a tablet. In some embodiments, the method further comprises granulating the composition with a binder solution to form a plurality of granules prior to the compressing.

In some embodiments, the method further comprises adding one or more salts, binders, sweeteners, buffering agents, colorants, humectants, oral care additives, preservatives, disintegration aids, flow aids, compressibility aids, or combinations thereof to the composition, the binder solution, or both prior to the compressing.

In some embodiments, the method further comprises coating the predetermined shape with a coating composition. In some embodiments, the coating composition comprises a flavorant.

The disclosure includes, without limitations, the following embodiments.

Embodiment 1: A method of preparing a pouched product for oral use, comprising: compressing a composition for oral use, wherein the composition comprises one or more water-soluble components, to form an agglomerate; sealing the agglomerate within one or more layers of fleece material and cutting to give a pouched agglomerate; and adding moisture to the pouched agglomerate in an amount sufficient to at least partially degrade the agglomerate, thereby providing the pouched product.

Embodiment 2: The method of Embodiment 1, wherein the one or more water-soluble components comprise a flavorant.

Embodiment 3: The method of Embodiment 1 or 2, wherein the one or more water-soluble components comprise an active ingredient.

Embodiment 4: The method of Embodiment 3, wherein the active ingredient is selected from the group consisting of a nicotinic component, nutraceuticals, botanicals, stimulants, amino acids, vitamins, cannabinoids, cannabamimetics, terpenes, pharmaceutical agents, and combinations thereof.

Embodiment 5: The method of Embodiment 4, wherein the active ingredient is a nicotinic component selected from the group consisting of nicotine, a nicotine salt, or a resin complex of nicotine. The method of claim 1, wherein the compressing comprises placing the composition for oral use within a tablet press.

Embodiment 6: The method of any of Embodiments 1 to 5, wherein the sealing step comprises providing a bottom layer and top layer of fleece material relative to the agglomerate.

Embodiment 7: The method of Embodiment 6, further comprising stretching the bottom layer, the top layer, or both the bottom and top layers.

Embodiment 8: The method of any of Embodiment 1 to 7, wherein the sealing comprises heat sealing.

Embodiment 9: The method of Embodiment 8, wherein the heat sealing is conducted via ultrasonic heating.

Embodiment 10: The method of any of Embodiments 1 to 9, wherein the sealing comprises the formation of a continuous seam through the one or more layers of fleece material and around the agglomerate.

Embodiment 11: The method of any of Embodiments 1 to 10, wherein the cutting comprises using a laser to define and cut an outer boundary of the fleece materials.

Embodiment 12: The method of any of Embodiments 1 to 11, wherein the cutting provides a shape with one or more rounded edges.

Embodiment 13: The method of any of Embodiments 1 to 12, wherein the shape has four or five sides.

Embodiment 14: The method of any of Embodiments 1 to 13, wherein the pouched product has a strength measured according to Coresta method Number 90 (June 2019) of about 5 N/mm in the machine and/or cross-direction.

Embodiment 15: The method of any of Embodiments 1 to 14, wherein the moisture is added via a dosing meter.

Embodiment 16: An oral pouched product prepared according to the method of any of Embodiments 1 to 15.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

Having thus described aspects of the disclosure in the foregoing general terms, reference will now be made to the accompanying drawings, which are not necessarily drawn to scale. The drawings are exemplary only, and should not be construed as limiting the disclosure.

FIG. 1 is a perspective view of a pouched product embodiment, taken across the width of the product, showing a pouch loaded with a composition of the present disclosure.

FIG. 2 is a perspective view of a further pouched product embodiment, taken across the width of the product, showing a pouch loaded with a composition of the present disclosure;

FIG. 3 is a perspective view of a pouched product embodiment, taken across the length of the product, showing a pouch loaded with a composition of the present disclosure.

FIG. 4 is another perspective view of a pouched product embodiment, taken across the length of the product, showing a pouch loaded with a composition of the present disclosure;

FIG. 5 is a front perspective view illustrating a pouched product with a first, non-limiting alternative shape according to an embodiment of the present disclosure;

FIG. 6 is a front perspective view illustrating a pouched product with a second, non-limiting alternative shape according to an embodiment of the present disclosure;

FIG. 7 is a front perspective view illustrating a pouched product with a third, non-limiting alternative shape according to an embodiment of the present disclosure;

FIG. 8A and FIG. 8B are, independently, front perspective views illustrating pouched product with a fourth, non-limiting alternative shape with different side lengths according to embodiments of the present disclosure;

FIG. 9 is a front perspective view illustrating a pouched product with a fifth, non-limiting alternative shape according to an embodiment of the present disclosure;

FIG. 10 is a front perspective view illustrating a pouched product with a sixth, non-limiting alternative shape according to an embodiment of the present disclosure; and

FIG. 11 is a general schematic flowchart of a non-limiting method of preparing pouched products according to certain embodiments.

### DETAILED DESCRIPTION

The present disclosure provides a composition enclosed in a pouch to form a pouched product configured for oral use, wherein the composition is loaded within the pouch at a density of about 0.45 g/cm³ or higher, the composition comprising: a filler in an amount of at least 20% by weight, based on the total weight of the composition; and at least one active ingredient, at least one flavorant, or both at least one active ingredient and at least one flavorant. The present disclosure further provides a method for the preparation of such a composition.

The present disclosure will now be described more fully hereinafter with reference to example embodiments thereof. These example embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements.

As used in this specification and the claims, the singular forms “a,” “an,” and “the” include plural referents unless the context clearly dictates otherwise.

The term “about” used throughout this specification is used to describe and account for small fluctuations. For example, the term “about” can refer to less than or equal to ±10%, such as less than or equal to ±5%, less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Reference to “dry weight percent” or “dry weight basis” refers to weight on the basis of dry ingredients (i.e., all ingredients except water). Reference to “wet weight” refers to the weight of the composition including water. Unless otherwise indicated, reference to “weight percent” of a composition reflects the total wet weight of the composition (i.e., including water).

### Composition

The composition as described herein comprises a filler in an amount of at least 20% by weight, based on the total weight of the composition, and at least one active ingredient, at least one flavorant, or both at least one active ingredient and at least one flavorant. The composition is loaded within the pouch at a density of at least about 0.45 g/cm³. In some embodiments, the composition may further comprise a salt, at least one sweetener, one or more organic acids, and various other additives. The relative amounts of the various components within the composition may vary, and typically are selected so as to provide the desired sensory and performance characteristics to the oral product. The example individual components of the composition are described herein below.

### Filler

Compositions as described herein include at least one filler. Such fillers may fulfill multiple functions, such as enhancing certain organoleptic properties such as texture and mouthfeel, enhancing cohesiveness or compressibility of the product, and the like. Generally, the fillers are porous particulate materials and are cellulose-based. For example, suitable fillers are any non-tobacco plant material or derivative thereof, including cellulose materials derived from such sources. Examples of cellulosic non-tobacco plant material include cereal grains (e.g., maize, oat, barley, rye, buckwheat, and the like), sugar beet (e.g., FIBREX® brand filler available from International Fiber Corporation), bran fiber, and mixtures thereof. Non-limiting examples of derivatives of non-tobacco plant material include starches (e.g., from potato, wheat, rice, corn), natural cellulose, and modified cellulosic materials. Additional examples of potential fillers include maltodextrin, dextrose, calcium carbonate, calcium phosphate, lactose, mannitol, xylitol, and sorbitol. Combinations of fillers can also be used.

In some embodiments, the filler comprises a starch. The term “starch” as used herein may refer to pure starch from any source, modified starch, or starch derivatives. Starch is present, typically in granular form, in almost all green plants and in various types of plant tissues and organs (e.g., seeds, leaves, rhizomes, roots, tubers, shoots, fruits, grains, and stems). Starch can vary in composition, as well as in granular shape and size. Often, starch from different sources has different chemical and physical characteristics. A specific starch can be selected for inclusion in the product based on the ability of the starch material to impart a specific organoleptic property to the product. Starches derived from various sources can be used. For example, major sources of starch include cereal grains (e.g., rice, wheat, and maize) and root vegetables (e.g., potatoes and cassava). Other examples of sources of starch include acorns, arrowroot, arracacha, bananas, barley, beans (e.g., favas, lentils, mung beans, peas, chickpeas), breadfruit, buckwheat, canna, chestnuts, colacasia, katakuri, kudzu, malanga, millet, oats, oca, Polynesian arrowroot, sago, sorghum, sweet potato, quinoa, rye, tapioca, taro, tobacco, water chestnuts, and yams. Certain starches are modified starches. A modified starch has undergone one or more structural modifications, often designed to alter its high heat properties. Some starches have been developed by genetic modifications, and are considered to be “modified” starches. Other starches are obtained and subsequently modified. For example, modified starches can be starches that have been subjected to chemical reactions, such as esterification, etherification, oxidation, depolymerization (thinning) by acid catalysis or oxidation in the presence of base, bleaching, transglycosylation and depolymerization (e.g., dextrinization in the presence of a catalyst), cross-linking, enzyme treatment, acetylation, hydroxypropylation, and/or partial hydrolysis. Other starches are modified by heat treatments, such as pregelatinization, dextrinization, and/or cold water swelling processes. Certain modified starches include monostarch phosphate, distarch glycerol, distarch phosphate esterified with sodium trimetaphosphate, phosphate distarch phosphate, acetylated distarch phosphate, starch acetate esterified with acetic anhydride, starch acetate esterified with vinyl acetate, acetylated distarch adipate, acetylated distarch glycerol, hydroxypropyl starch, hydroxypropyl distarch glycerol, starch sodium octenyl succinate. In some embodiments, the filler comprises rice starch.

In some embodiments, the filler comprises a cellulosic material. One particularly suitable filler for use in the products described herein is microcrystalline cellulose (“mcc”). The mcc may be synthetic or semi-synthetic, or it may be obtained entirely from natural celluloses. The mcc may be selected from the group consisting of AVICEL® grades PH-100, PH-102, PH-103, PH-105, PH-112, PH-113, PH-200, PH-300, PH-302, VIVACEL® grades 101, 102, 12, 20 and EMOCEL® grades 50M and 90M, and the like, and mixtures thereof. In some embodiments, the product comprises mcc. The quantity of mcc present in the product as described herein may vary according to the desired properties.

In some embodiments, the filler comprises a cellulose derivative, such as cellulose ethers (including carboxyalkyl ethers), meaning cellulose polymers with the hydrogen of one or more hydroxyl groups in the cellulose structure replaced with an alkyl, hydroxyalkyl, or aryl group. Non-limiting examples of such cellulose derivatives include methylcellulose, hydroxypropylcellulose (“HPC”), hydroxypropylmethylcellulose (“HPMC”), hydroxyethyl cellulose, and carboxymethylcellulose (“CMC”). Suitable cellulose ethers include hydroxypropylcellulose, such as Klucel H from Aqualon Co.; hydroxypropylmethylcellulose, such as Methocel K4MS from DuPont; hydroxyethylcellulose, such as Natrosol 250 MRCS from Aqualon Co.; methylcellulose, such as Methocel A4M, K4M, and E15 from DuPont.; and sodium carboxymethylcellulose, such as CMC 7HF, CMC 7LF, and CMC 7H4F from Aqualon Co. In some embodiments, at least one filler is one or more cellulose ethers (e.g., a single cellulose ether or a combination of several cellulose ethers, such as two or three, for example). In some embodiments, the filler is a cellulose ether selected from the group consisting of methylcellulose, hydroxypropylcellulose, hydroxypropylmethylcellulose, hydroxyethyl cellulose, carboxymethylcellulose, and combinations thereof. In some embodiments, the at least one filler is carboxymethylcellulose.

Other suitable fillers include gums, for example, a natural gum. As used herein, a natural gum refers to polysaccharide materials of natural origin that have binding properties, and which are also useful as a thickening or gelling agents. Representative natural gums derived from plants, which are typically water soluble to some degree, include xanthan gum, guar gum, gum arabic, ghatti gum, gum tragacanth, karaya gum, locust bean gum, gellan gum, and combinations thereof.

Additional examples of potential fillers include maltodextrin, dextrose, calcium carbonate, calcium phosphate, lactose, mannitol, xylitol, and sorbitol. In some embodiments, the filler comprises calcium carbonate. In some embodiments, the filler comprises maltodextrin. Combinations of fillers can also be used. In some embodiments, the filler is a combination of calcium carbonate, maltodextrin, microcrystalline cellulose, and rice starch.

In some embodiments, the filler comprises one or more sugar alcohols. Sugar alcohols are polyols derived from monosaccharides or disaccharides that have a partially or fully hydrogenated form. Sugar alcohols have, for example, about 4 to about 20 carbon atoms and include erythritol, arabitol, ribitol, isomalt, maltitol, dulcitol, iditol, mannitol, xylitol, lactitol, sorbitol, and combinations thereof (e.g., hydrogenated starch hydrolysates). In some embodiments, the filler comprises erythritol, isomalt, maltitol, mannitol, sorbitol, or a combination thereof. In some embodiments, filler is a combination of mannitol and maltodextrin. In some embodiments, the filler comprises isomalt. Isomalt is an equimolar mixture of two disaccharides, each composed of two sugars as follows: glucose and mannitol (α-D-glucopyranosido-1,6-mannitol); and glucose and sorbitol (α-D-glucopyranosido-1,6-sorbitol). In some embodiments, the filler comprises a mixture of glucose and starch-derived polysaccharides. One such suitable mixture of glucose and starch-derived polysaccharides is EMDEX®, available from JRS PHARMA LP, USA, 2981 Route 22, Patterson, N.Y. 12563-2359. In some embodiments, the filler comprises EMDEX®. In some embodiments, the filler comprises a combination of isomalt and EMDEX®. In some embodiments, filler is a combination of isomalt and maltodextrin. In some embodiments, filler is a combination of microcrystalline cellulose, isomalt, and maltodextrin.

The amount of filler can vary, but is typically greater than about 20%, and up to about 95% of the composition by weight, based on the total weight of the composition. A typical range of filler within the composition can be from about 20 to about 95% by total weight of the composition, for example, from about 20, about 25, about 30, about 35, about 40, about 45, about 50, about 55, about 60, about 65, about 70, about 75, about 80, about 85, about 90, or about 95% by weight (e.g., about 20 to about 90%, or about 25 to about 85% by weight). In certain embodiments, the amount of filler is at least about 20% by weight, such as at least about 25%, or at least about 30%, or at least about 35%, at least about 40%, or at least about 45%, or at least about 50%, or at least about 55%, or at least about 60%, or at least about 65%, or at least about 70%, or at least about 75%, or at least about 80%, or at least about 85%, or at least about 90%, based on the total weight of the composition. It is to be understood that in embodiments where the composition comprises more than one filler, the stated weight basis of the filler reflects the total weight of the combination of fillers, based on the total weight of the composition.

### Binders

A binder (or combination of binders) may be employed in certain embodiments, in amounts sufficient to provide the desired physical attributes and physical integrity to the composition, and binders also often function as thickening or gelling agents. Typical binders can be organic or inorganic, or a combination thereof. Representative binders include cellulose derivatives (e.g., cellulose ethers), povidone, sodium alginate, starch-based binders, pectin, gums, carrageenan, pullulan, zein, and the like, and combinations thereof. In some embodiments, the binder comprises pectin or carrageenan or combinations thereof.

The amount of binder utilized in the composition can vary based on the binder and the desired composition properties, but is typically up to about 30% by weight, and certain embodiments are characterized by a binder content of at least about 0.1% by weight, such as about 0.5 to about 30% by weight, or about 1 to about 10% by weight, based on the total weight of the composition.

In one embodiment, the binder comprises a cellulose derivative. In certain embodiments, the cellulose derivative is a cellulose ether (including carboxyalkyl ethers), meaning a cellulose polymer with the hydrogen of one or more hydroxyl groups in the cellulose structure replaced with an alkyl, hydroxyalkyl, or aryl group. Non-limiting examples of such cellulose derivatives include methylcellulose, hydroxypropylcellulose (“HPC”), hydroxypropylmethylcellulose (“HPMC”), hydroxyethyl cellulose, and carboxymethylcellulose (“CMC”). In one embodiment, the cellulose derivative is one or more of methylcellulose, HPC, HPMC, hydroxyethyl cellulose, and CMC. In some embodiments, the cellulose derivative is HPC. In one embodiment, the cellulose derivative is a combination of HPC and HPMC. In some embodiments, the composition comprises from about 1 to about 5% by weight of HPC, for example, from about 1%, about 2%, or about 3%, to about 4%, or about 5% by weight of the composition.

In certain embodiments, the binder includes a gum, for example, a natural gum. As used herein, a natural gum refers to polysaccharide materials of natural origin that have binding properties, and which are also useful as a thickening or gelling agents. Representative natural gums derived from plants, which are typically water soluble to some degree, include xanthan gum, guar gum, gum arabic, ghatti gum, gum tragacanth, karaya gum, locust bean gum, gellan gum, and combinations thereof. When present, natural gum binder materials are typically present in an amount of up to about 5% by weight, for example, from about 0.1, about 0.2, about 0.3, about 0.4, about 0.5, about 0.6, about 0.7, about 0.8, about 0.9, or about 1%, to about 2, about 3, about 4, or about 5% by weight, based on the total weight of the composition.

In certain embodiments, the binder includes an alginate (e.g., sodium or ammonium alginate). When present, alginate binder materials are typically present in an amount of up to about 1% by weight, for example, from about 0.1, about 0.2, about 0.3, about 0.4, or about 0.5, to about 0.6, about 0.7, about 0.8, about 0.9, or about 1%, by weight, based on the total weight of the composition.

### Active Ingredient

In some embodiments, the composition as disclosed herein includes one or more active ingredients. As used herein, an “active ingredient” refers to one or more substances belonging to any of the following categories: API (active pharmaceutical substances), food additives, natural medicaments, and naturally occurring substances that can have an effect on humans. Example active ingredients include any ingredient known to impact one or more biological functions within the body, such as ingredients that furnish pharmacological activity or other direct effect in the diagnosis, cure, mitigation, treatment, or prevention of disease, or which affect the structure or any function of the body of humans (e.g., provide a stimulating action on the central nervous system, have an energizing effect, an antipyretic or analgesic action, or an otherwise useful effect on the body). In some embodiments, the active ingredient may be of the type generally referred to as dietary supplements, nutraceuticals, “phytochemicals” or “functional foods”. These types of additives are sometimes defined in the art as encompassing substances typically available from naturally-occurring sources (e.g., botanical materials) that provide one or more advantageous biological effects (e.g., health promotion, disease prevention, or other medicinal properties), but are not classified or regulated as drugs.

Non-limiting examples of active ingredients include those falling in the categories of botanical ingredients (e.g., hemp, lavender, peppermint, eucalyptus, rooibos, fennel, cloves, chamomile, basil, rosemary, clove, citrus, ginger, cannabis, ginseng, maca, and tisanes), stimulants (e.g., caffeine or guarana), amino acids (e.g., taurine, theanine, phenylalanine, tyrosine, and tryptophan), vitamins (e.g., B6, B12, and C), antioxidants, nicotine components, pharmaceutical ingredients (e.g., nutraceutical and medicinal ingredients), cannabinoids (e.g., tetrahydrocannabinol (THC) or cannabidiol (CBD)) and/or melatonin. Each of these categories is further described herein below. The particular choice of active ingredients will vary depending upon the desired flavor, texture, and desired characteristics of the particular product.

Furthermore, any of the aforementioned types of active ingredients may be encapsulated in the composition, the final product, or both to avoid chemical degradation or reduce strong taste of these actives, including but not limited to caffeine, Vitamin A, and iron (Fe). Additionally, these encapsulated actives may need to be paired with an excipient in the composition to increase their solubility and/or bioavailability. Non-limiting examples of these excipients include beta-carotene, lycopene, Vitamin D, Vitamin E, Co-enzyme Q10, Vitamin K, and curcumin.

The particular percentages of active ingredients present will vary depending upon the desired characteristics of the particular product. Typically, an active ingredient or combination thereof is present in a total concentration of at least about 0.001% by weight of the composition, such as in a range from about 0.001% to about 20%. In some embodiments, the active ingredient or combination of active ingredients is present in a concentration from about 0.1% w/w to about 10% by weight, such as, e.g., from about 0.5% w/w to about 10%, from about 1% to about 10%, from about 1% to about 5% by weight, based on the total weight of the composition. In some embodiments, the active ingredient or combination of active ingredients is present in a concentration of from about 0.001%, about 0.01%, about 0.1%, or about 1%, up to about 20% by weight, such as, e.g., from about 0.001%, about 0.002%, about 0.003%, about 0.004%, about 0.005%, about 0.006%, about 0.007%, about 0.008%, about 0.009%, about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight, based on the total weight of the composition. Further suitable ranges for specific active ingredients are provided herein below.

### Botanical

In some embodiments, the active ingredient comprises a botanical ingredient. As used herein, the term “botanical ingredient” or “botanical” refers to any plant material or fungal-derived material, including plant material in its natural form and plant material derived from natural plant materials, such as extracts or isolates from plant materials or treated plant materials (e.g., plant materials subjected to heat treatment, fermentation, bleaching, or other treatment processes capable of altering the physical and/or chemical nature of the material). For the purposes of the present disclosure, a “botanical” includes, but is not limited to, “herbal materials,” which refer to seed-producing plants that do not develop persistent woody tissue and are often valued for their medicinal or sensory characteristics (e.g., teas or tisanes). Reference to botanical material as “non-tobacco” is intended to exclude tobacco materials (i.e., does not include any Nicotiana species).

When present, a botanical is typically at a concentration of from about 0.01% w/w to about 10% by weight, such as, e.g., from about 0.01% w/w, about 0.05%, about 0.1%, or about 0.5%, to about 1%, about 2%, about 3%, about 4%, about 5%, about 6%, about 7%, about 8%, about 9%, or about 10%, about 11%, about 12%, about 13%, about 14%, or about 15% by weight, based on the total weight of the composition.

The botanical materials useful in the present disclosure may comprise, without limitation, any of the compounds and sources set forth herein, including mixtures thereof. Certain botanical materials of this type are sometimes referred to as dietary supplements, nutraceuticals, “phytochemicals” or “functional foods.” Certain botanicals, as the plant material or an extract thereof, have found use in traditional herbal medicine, and are described further herein. Non-limiting examples of botanicals or botanical-derived materials include ashwagandha, Bacopa monniera, baobab, basil, Centella asiatica, Chai-hu, chamomile, cherry blossom, chlorophyll, cinnamon, citrus, cloves, cocoa, cordyceps, curcumin, damiana, Dorstenia arifolia, Dorstenia odorata, essential oils, eucalyptus, fennel, Galphimia glauca, ginger, Ginkgo biloba, ginseng (e.g., Panax ginseng), green tea, Griffonia simplicifolia, guarana, hemp, hops, jasmine, Kaempferia parviflora (Thai ginseng), kava, lavender, lemon balm, lemongrass, licorice, lutein, maca, matcha, Nardostachys chinensis, oil-based extract of Viola odorata, peppermint, quercetin, resveratrol, Rhizoma gastrodiae, Rhodiola, rooibos, rose essential oil, rosemary, Sceletium tortuosum, Schisandra, Skullcap, spearmint extract, Spikenard, terpenes, tisanes, turmeric, Turnera aphrodisiaca, valerian, white mulberry, and Yerba mate. In some embodiments, the botanical material is in an encapsulated form.

In some embodiments, the active ingredient comprises or further comprises ashwagandha. Ashwagandha (Withania somnifera) is a plant in the Solanaceae (nightshade) family. As an herb, Ashwagandha has found use in the Indian Ayurvedic system of medicine, where it is also known as “Indian Winter cherry” or “Indian Ginseng.”

In some embodiments, the active ingredient comprises or further comprises baobab. Baobab is the common name of a family of deciduous trees of the genus Adansonia. The fruit pulp and seeds of the Baobab are consumed, generally after drying, as a food or nutritional supplement.

In some embodiments, the active ingredient comprises or further comprises chlorophyll. Chlorophyll is any of several related green pigments found in the mesosomes of cyanobacteria, as well as in the chloroplasts of algae and plants. Chlorophyll has been used as a food additive (colorant) and a nutritional supplement. Chlorophyll may be provided either from native plant materials (e.g., botanicals) or in an extract or dried powder form.

In some embodiments, the active ingredient comprises or further comprises cordyceps. Cordyceps is a diverse genus of ascomycete (sac) fungi which are abundant in humid temperate and tropical forests. Members of the cordyceps family are used extensively in traditional Chinese medicine.

In some embodiments, the active ingredient comprises or further comprises damiana. Damiana is a small, woody shrub of the family Passifloraceae. It is native to southern Texas, Central America, Mexico, South America, and the Caribbean. Damiana produces small, aromatic flowers, followed by fruits that taste similar to figs. The extract from damiana has been found to suppress aromatase activity, including the isolated compounds pinocembrin and acacetin.

In some embodiments, the active ingredient comprises or further comprises guarana. Guarana is a climbing plant in the family Sapindaceae, native to the Amazon basin. The seeds from its fruit, which are about the size of a coffee bean, have a high concentration of caffeine and, consequently, stimulant activity.

In some embodiments, the active ingredient comprises or further comprises ginseng. Ginseng is the root of plants of the genus Panax, which are characterized by the presence of unique steroid saponin phytochemicals (ginsenosides) and gintonin. Ginseng finds use as a dietary supplement in energy drinks or herbal teas, and in traditional medicine. Cultivated species include Korean ginseng (P. ginseng), South China ginseng (P. notoginseng), and American ginseng (P. quinquefolius). American ginseng and Korean ginseng vary in the type and quantity of various ginsenosides present. In some embodiments, the ginseng is American ginseng or Korean ginseng. In specific embodiments, the active ingredient comprises or further comprises Korean ginseng.

In some embodiments, the active ingredient comprises or further comprises lemon balm extract. Lemon balm (Melissa officinalis) is a mildly lemon-scented herb from the same family as mint (Lamiaceae). The herb is native to Europe, North Africa, and West Asia. The tea of lemon balm, as well as the essential oil and the extract, are used in traditional and alternative medicine.

In some embodiments, the active ingredient comprises maca. Maca is a plant that grows in central Peru in the high plateaus of the Andes Mountains. It is a relative of the radish, and has an odor similar to butterscotch. Maca has been used in traditional (e.g., Chinese) medicine.

### Stimulants

In some embodiments, the active ingredient comprises one or more stimulants. As used herein, the term “stimulant” refers to a material that increases activity of the central nervous system and/or the body, for example, enhancing focus, cognition, vigor, mood, alertness, and the like. Non-limiting examples of stimulants include caffeine, theacrine, theobromine, and theophylline. Theacrine (1,3,7,9-tetramethyluric acid) is a purine alkaloid which s structurally related to caffeine, and possesses stimulant, analgesic, and anti-inflammatory effects. Present stimulants may be natural, naturally derived, or wholly synthetic. For example, certain botanical materials (guarana, tea, coffee, cocoa, and the like) may possess a stimulant effect by virtue of the presence of e.g., caffeine or related alkaloids, and accordingly are “natural” stimulants. By “naturally derived” is meant the stimulant (e.g., caffeine, theacrine) is in a purified form, outside its natural (e.g., botanical) matrix. For example, caffeine can be obtained by extraction and purification from botanical sources (e.g., tea). By “wholly synthetic”, it is meant that the stimulant has been obtained by chemical synthesis. In some embodiments, the active ingredient comprises caffeine. In some embodiments, the caffeine is present in an encapsulated form. On example of an encapsulated caffeine is Vitashure®, available from Balchem Corp., 52 Sunrise Park Road, New Hampton, N.Y., 10958. In some embodiments, the active ingredient comprises theacrine. In some embodiments, the active ingredient comprises a combination of caffeine and theacrine.

When present, a stimulant or combination of stimulants (e.g., caffeine, theacrine, and combinations thereof) is typically at a concentration of from about 0.1% w/w to about 15% by weight, such as, e.g., from about 0.1% w/w, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, about 10%, about 11%, about 12%, about 13%, about 14%, or about 15% by weight, based on the total weight of the composition.

### Amino Acids

In some embodiments, the active ingredient comprises an amino acid. As used herein, the term “amino acid” refers to an organic compound that contains amine (—NH₂) and carboxyl (—COOH) or sulfonic acid (SO₃H) functional groups, along with a side chain (R group), which is specific to each amino acid. Amino acids may be proteinogenic or non-proteinogenic. By “proteinogenic” is meant that the amino acid is one of the twenty naturally occurring amino acids found in proteins. The proteinogenic amino acids include alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine. By “non-proteinogenic” is meant that either the amino acid is not found naturally in protein, or is not directly produced by cellular machinery (e.g., is the product of post-translational modification). Non-limiting examples of non-proteinogenic amino acids include gamma-aminobutyric acid (GABA), taurine (2-aminoethanesulfonic acid), theanine (L-γ-glutamylethylamide), hydroxyproline, and beta-alanine.

When present, an amino acid or combination of amino acids (e.g., taurine, theanine, and combinations thereof) is typically at a concentration of from about 0.1% w/w to about 15% by weight, such as, e.g., from about 0.1% w/w, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, about 10%, about 11%, about 12%, about 13%, about 14%, or about 15% by weight, based on the total weight of the composition.

In some embodiments, the amino acid is taurine, theanine, phenylalanine, tyrosine, tryptophan, or a combination thereof. In some embodiments, the amino acid is taurine. In some embodiments, the active ingredient comprises a combination of taurine and caffeine. In some embodiments, the active ingredient comprises a combination of taurine, caffeine, and guarana. In some embodiments, the active ingredient comprises a combination of taurine, maca, and cordyceps. In some embodiments, the active ingredient comprises a combination of theanine and caffeine. In some embodiments, the active ingredient comprises a combination of theanine and caffeine. In some embodiments, the active ingredient comprises a combination of theanine and GABA. In some embodiments, the active ingredient comprises a combination of theanine, GABA, and lemon balm. In some embodiments, the active ingredient comprises a combination of caffeine, taurine, and Vitamin C. In some embodiments, the active ingredient is a combination of caffeine, theanine, and ginseng. In some embodiments, the active ingredient comprises taurine.

### Vitamins

In some embodiments, the active ingredient comprises a vitamin or combination of vitamins. As used herein, the term “vitamin” refers to an organic molecule (or related set of molecules) that is an essential micronutrient needed for the proper functioning of metabolism in a mammal. There are thirteen vitamins required by human metabolism, which are: vitamin A (as all-trans-retinol, all-trans-retinyl-esters, as well as all-trans-beta-carotene and other provitamin A carotenoids), vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folic acid or folate), vitamin B12 (cobalamins), vitamin C (ascorbic acid), vitamin D (calciferols), vitamin E (tocopherols and tocotrienols), and vitamin K (quinones). In some embodiments, the active ingredient comprises vitamin C. In some embodiments, the active ingredient is a combination of vitamin C, caffeine, and taurine. In some embodiments, the active ingredient comprises one or more of vitamin B6 and B12. In some embodiments, the active ingredient comprises theanine and one or more of vitamin B6 and B12.

When present, a vitamin or combination of vitamins (e.g., vitamin B6, vitamin B12, vitamin E, vitamin C, or a combination thereof) is typically at a concentration of from about 0.01% w/w to about 1% by weight, such as, e.g., from about 0.01%, about 0.02%, about 0.03%, about 0.04%, about 0.05%, about 0.06%, about 0.07%, about 0.08%, about 0.09%, or about 0.1% w/w, to about 0.2%, about 0.3%, about 0.4%, about 0.5% about 0.6%, about 0.7%, about 0.8%, about 0.9%, or about 1% by weight, based on the total weight of the composition.

In some embodiments, the active ingredient comprises vitamin A. In some embodiments, the vitamin A is encapsulated. In some embodiments, the vitamin is vitamin B6, vitamin B12, vitamin E, vitamin C, or a combination thereof. In some embodiments, the active ingredient comprises a combination of vitamin B6, caffeine, and theanine. In some embodiments, the active ingredient comprises vitamin B6, vitamin B12, and taurine. In some embodiments, the active ingredient comprises a combination of vitamin B6, vitamin B12, ginseng, and theanine. In some embodiments, the active ingredient comprises a combination of vitamin C, baobab, and chlorophyll.

In certain embodiments, the active ingredient is selected from the group consisting of caffeine, taurine, GABA, theanine, vitamin C, lemon balm extract, ginseng, citicoline, sunflower lecithin, and combinations thereof. For example, the active ingredient can include a combination of caffeine, theanine, and optionally ginseng. In another embodiment, the active ingredient includes a combination of theanine, gamma-amino butyric acid (GABA), and lemon balm extract. In a further embodiment, the active ingredient includes theanine, theanine and tryptophan, or theanine and one or more B vitamins (e.g., vitamin B6 or B12). In a still further embodiment, the active ingredient includes a combination of caffeine, taurine, and vitamin C, optionally further including one or more B vitamins (e.g., vitamin B6 or B12). A magnesium salt (e.g., magnesium gluconate) could be added to any of the above combinations, particularly combinations also including theanine.

In some embodiments, the active ingredient comprises a mineral. As used herein, the term “mineral” refers to an inorganic molecule (or related set of molecules) that is an essential micronutrient needed for the proper functioning of various systems in a mammal. Non-limiting examples of minerals include iron, zinc, copper, selenium, chromium, cobalt, manganese, calcium, phosphorus, sulfur, magnesium, and the like. In some embodiments, the active ingredient comprises iron. Suitable sources of iron include, but are not limited to, ferrous salts such as ferrous sulfate and ferrous gluconate. In some embodiments, the iron is encapsulated.

In some embodiments, the active ingredient as described herein may be sensitive to degradation (e.g., oxidative, photolytic, thermal, evaporative) during processing or upon storage of the oral product. In such embodiments, the active ingredient (such as caffeine, vitamin A, and iron (Fe)) may be encapsulated, or the matrix otherwise modified with fillers, binders, and the like, to provide enhanced stability to the active ingredient. For example, binders such as functional celluloses (e.g., cellulose ethers including, but not limited to, hydroxypropyl cellulose) may be employed to enhance stability of such actives toward degradation. Additionally, encapsulated actives may need to be paired with an excipient in the composition to increase their solubility and/or bioavailability. Non-limiting examples of suitable excipients include beta-carotene, lycopene, Vitamin D, Vitamin E, Co-enzyme Q10, Vitamin K, and curcumin.

In other embodiments, in order to provide a desired concentration of the active ingredient by weight, an initial quantity of the active ingredient may be increased to compensate for a gradual degradative loss. Accordingly, larger initial amounts than those disclosed herein are contemplated by the present disclosure.

### Antioxidants

In some embodiments, the active ingredient comprises one or more antioxidants. As used herein, the term “antioxidant” refers to a substance which prevents or suppresses oxidation by terminating free radical reactions, and may delay or prevent some types of cellular damage. Antioxidants may be naturally occurring or synthetic. Naturally occurring antioxidants include those found in foods and botanical materials. Non-limiting examples of antioxidants include certain botanical materials, vitamins, polyphenols, and phenol derivatives.

Examples of botanical materials which are associated with antioxidant characteristics include without limitation acai berry, alfalfa, allspice, annatto seed, apricot oil, basil, bee balm, wild bergamot, black pepper, blueberries, borage seed oil, bugleweed, cacao, calamus root, catnip, catuaba, cayenne pepper, chaga mushroom, chervil, cinnamon, dark chocolate, potato peel, grape seed, ginseng, gingko biloba, Saint John's Wort, saw palmetto, green tea, black tea, black cohosh, cayenne, chamomile, cloves, cocoa powder, cranberry, dandelion, grapefruit, honeybush, echinacea, garlic, evening primrose, feverfew, ginger, goldenseal, hawthorn, hibiscus flower, jiaogulan, kava, lavender, licorice, marjoram, milk thistle, mints (menthe), oolong tea, beet root, orange, oregano, papaya, pennyroyal, peppermint, red clover, rooibos (red or green), rosehip, rosemary, sage, clary sage, savory, spearmint, spirulina, slippery elm bark, sorghum bran hi-tannin, sorghum grain hi-tannin, sumac bran, comfrey leaf and root, goji berries, gutu kola, thyme, turmeric, uva ursi, valerian, wild yam root, wintergreen, yacon root, yellow dock, yerba mate, yerba santa, Bacopa monniera, Withania somnifera, Lion's mane, and Silybum marianum. Such botanical materials may be provided in fresh or dry form, essential oils, or may be in the form of an extracts. The botanical materials (as well as their extracts) often include compounds from various classes known to provide antioxidant effects, such as minerals, vitamins, isoflavones, phytoesterols, allyl sulfides, dithiolthiones, isothiocyanates, indoles, lignans, flavonoids, polyphenols, and carotenoids. Examples of compounds found in botanical extracts or oils include ascorbic acid, peanut endocarb, resveratrol, sulforaphane, beta-carotene, lycopene, lutein, co-enzyme Q, carnitine, quercetin, kaempferol, and the like. See, e.g., Santhosh et al., Phytomedicine, 12(2005) 216-220, which is incorporated herein by reference.

Non-limiting examples of other suitable antioxidants include citric acid, Vitamin E or a derivative thereof, a tocopherol, epicatechol, epigallocatechol, epigallocatechol gallate, erythorbic acid, sodium erythorbate, 4-hexylresorcinol, theaflavin, theaflavin monogallate A or B, theaflavin digallate, phenolic acids, glycosides, quercitrin, isoquercitrin, hyperoside, polyphenols, catechols, resveratrols, oleuropein, butylated hydroxyanisole (BHA), butylated hydroxytoluene (BHT), tertiary butylhydroquinone (TBHQ), and combinations thereof. In some embodiments, the antioxidant is Vitamin E or a derivative thereof, a flavonoid, a polyphenol, a carotenoid, or a combination thereof.

When present, an antioxidant is typically at a concentration of from about 0.001% w/w to about 10% by weight, such as, e.g., from about 0.001%, about 0.005%, about 0.01% w/w, about 0.05%, about 0.1%, or about 0.5%, to about 1%, about 2%, about 3%, about 4%, about 5%, about 6%, about 7%, about 8%, about 9%, or about 10%, based on the total weight of the composition.

### Nicotine Component

In certain embodiments, the active ingredient comprises a nicotine component. By “nicotine component” is meant any suitable form of nicotine (e.g., free base or salt) for providing oral absorption of at least a portion of the nicotine present. Typically, the nicotine component is selected from the group consisting of nicotine free base and a nicotine salt. In some embodiments, the nicotine component is nicotine in its free base form, which easily can be adsorbed in for example, a microcrystalline cellulose material to form a microcrystalline cellulose-nicotine carrier complex. See, for example, the discussion of nicotine in free base form in US Pat. Pub. No. 2004/0191322 to Hansson, which is incorporated herein by reference.

In some embodiments, at least a portion of the nicotine component can be employed in the form of a salt. Salts of nicotine can be provided using the types of ingredients and techniques set forth in U.S. Pat. No. 2,033,909 to Cox et al. and Perfetti, Beitrage Tabakforschung Int., 12: 43-54 (1983), which are incorporated herein by reference. Additionally, salts of nicotine are available from sources such as Pfaltz and Bauer, Inc. and K&K Laboratories, Division of ICN Biochemicals, Inc. Typically, the nicotine component is selected from the group consisting of nicotine free base, a nicotine salt such as hydrochloride, dihydrochloride, monotartrate, bitartrate, sulfate, salicylate, and nicotine zinc chloride. In some embodiments, the nicotine component is nicotine bitartrate.

In some embodiments, at least a portion of the nicotine can be in the form of a resin complex of nicotine, where nicotine is bound in an ion-exchange resin, such as nicotine polacrilex, which is nicotine bound to, for example, a polymethacrilic acid, such as Amberlite IRP64, Purolite C115HMR, or Doshion P551. See, for example, U.S. Pat. No. 3,901,248 to Lichtneckert et al., which is incorporated herein by reference. Another example is a nicotine-polyacrylic carbomer complex, such as with Carbopol 974P. In some embodiments, nicotine may be present in the form of a nicotine polyacrylic complex.

Typically, the nicotine component (calculated as the free base) when present, is in a concentration of at least about 0.001% by weight of the composition, such as in a range from about 0.001% to about 10%. In some embodiments, the nicotine component is present in a concentration from about 0.1% w/w to about 10% by weight, such as, e.g., from about 0.1% w/w, about 0.2%, about 0.3%, about 0.4%, about 0.5% about 0.6%, about 0.7%, about 0.8%, or about 0.9%, to about 1%, about 2%, about 3%, about 4%, about 5%, about 6%, about 7%, about 8%, about 9%, or about 10% by weight, calculated as the free base and based on the total weight of the composition. In some embodiments, the nicotine component is present in a concentration from about 0.1% w/w to about 3% by weight, such as, e.g., from about 0.1% w/w to about 2.5%, from about 0.1% to about 2.0%, from about 0.1% to about 1.5%, or from about 0.1% to about 1% by weight, calculated as the free base and based on the total weight of the composition.

In some embodiments, the products or compositions of the disclosure can be characterized as completely free or substantially free of any nicotine component (e.g., any embodiment as disclosed herein may be completely or substantially free of any nicotine component). By “substantially free” is meant that no nicotine has been intentionally added, beyond trace amounts that may be naturally present in e.g., a botanical material. For example, certain embodiments can be characterized as having less than 0.001% by weight of nicotine, or less than 0.0001%, or even 0% by weight of nicotine, calculated as the free base.

In some embodiments, the active ingredient comprises a nicotine component (e.g., any product or composition of the disclosure, in addition to comprising any active ingredient or combination of active ingredients as disclosed herein, may further comprise a nicotine component). In some embodiments, the active ingredient comprises a combination of nicotine and ginseng. In some embodiments, the active ingredient comprises a combination of nicotine and caffeine. In some embodiments, the active ingredient comprises a combination of nicotine and guarana.

### Cannabinoids

In some embodiments, the active ingredient comprises one or more cannabinoids. As used herein, the term “cannabinoid” refers to a class of diverse natural or synthetic chemical compounds that acts on cannabinoid receptors (i.e., CB1 and CB2) in cells that alter neurotransmitter release in the brain. Cannabinoids are cyclic molecules exhibiting particular properties such as the ability to easily cross the blood-brain barrier. Cannabinoids may be naturally occurring (Phytocannabinoids) from plants such as cannabis, (endocannabinoids) from animals, or artificially manufactured (synthetic cannabinoids). Cannabis species express at least 85 different phytocannabinoids, and these may be divided into subclasses, including cannabigerols, cannabichromenes, cannabidiols, tetrahydrocannabinols, cannabinols and cannabinodiols, and other cannabinoids, such as cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), and tetrahydrocannabivarinic acid (THCV A).

In some embodiments, the cannabinoid is selected from the group consisting of cannabigerol (CBG), cannabichromene (CBC), cannabidiol (CBD), tetrahydrocannabinol (THC), cannabinol (CBN) and cannabinodiol (CBDL), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabinerolic acid, cannabidiolic acid (CBDA), Cannabinol propyl variant (CBNV), cannabitriol (CBO), tetrahydrocannabmolic acid (THCA), tetrahydrocannabivarinic acid (THCV A), and mixtures thereof. In some embodiments, the cannabinoid comprises at least tetrahydrocannabinol (THC). In some embodiments, the cannabinoid is tetrahydrocannabinol (THC). In some embodiments, the cannabinoid comprises at least cannabidiol (CBD). In some embodiments, the cannabinoid is cannabidiol (CBD). In some embodiments, the CBD is synthetic CBD. Notably, CBD has a log P value of about 6.5, making it insoluble in an aqueous environment (e.g., saliva).

In some embodiments, the cannabinoid (e.g., CBD) is added to the oral product in the form of an isolate. An isolate is an extract from a plant, such as cannabis, where the active material of interest (in this case the cannabinoid, such as CBD) is present in a high degree of purity, for example greater than 95%, greater than 96%, greater than 97%, greater than 98%, or around 99% purity.

In some embodiments, the cannabinoid is an isolate of CBD in a high degree of purity, and the amount of any other cannabinoid in the oral product is no greater than about 1% by weight of the oral product, such as no greater than about 0.5% by weight of the oral product, such as no greater than about 0.1% by weight of the oral product, such as no greater than about 0.01% by weight of the oral product.

The choice of cannabinoid and the particular percentages thereof which may be present within the disclosed oral product will vary depending upon the desired flavor, texture, and other characteristics of the oral product.

In some embodiments, the cannabinoid (such as CBD) is present in the composition in a concentration of at least about 0.001% by weight of the oral product, such as in a range from about 0.001% to about 2% by weight of the oral product. In some embodiments, the cannabinoid (such as CBD) is present in the composition in a concentration of from about 0.1% to about 1.5% by weight, based on the total weight of the composition. In some embodiments, the cannabinoid (such as CBD) is present in a concentration from about 0.4% to about 1.5% by weight, based on the total weight of the oral composition.

Alternatively, or in addition to the cannabinoid, the active ingredient may include a cannabimimetic, which is a class of compounds derived from plants other than cannabis that have biological effects on the endocannabinoid system similar to cannabinoids. Examples include yangonin, alpha-amyrin or beta-amyrin (also classified as terpenes), cyanidin, curcumin (tumeric), catechin, quercetin, salvinorin A, N-acylethanolamines, and N-alkylamide lipids. Such compounds can be used in the same amounts and ratios noted herein for cannabinoids.

### Terpenes

Active ingredients suitable for use in the present disclosure can also be classified as terpenes, many of which are associated with biological effects, such as calming effects. Terpenes are understood to have the general formula of (C₅H₈)ₙ and include monoterpenes, sesquiterpenes, and diterpenes. Terpenes can be acyclic, monocyclic or bicyclic in structure. Some terpenes provide an entourage effect when used in combination with cannabinoids or cannabimimetics. Examples include beta-caryophyllene, linalool, limonene, beta-citronellol, linalyl acetate, pinene (alpha or beta), geraniol, carvone, eucalyptol, menthone, iso-menthone, piperitone, myrcene, beta-bourbonene, and germacrene, which may be used singly or in combination.

In some embodiments, the terpene is a terpene derivable from a phytocannabinoid producing plant, such as a plant from the stain of the Cannabis sativa species, such as hemp. Suitable terpenes in this regard include so-called “C10” terpenes, which are those terpenes comprising 10 carbon atoms, and so-called “C15” terpenes, which are those terpenes comprising 15 carbon atoms. In some embodiments, the active ingredient comprises more than one terpene. For example, the active ingredient may comprise one, two, three, four, five, six, seven, eight, nine, ten or more terpenes as defined herein. In some embodiments, the terpene is selected from pinene (alpha and beta), geraniol, linalool, limonene, carvone, eucalyptol, menthone, iso-menthone, piperitone, myrcene, beta-bourbonene, germacrene and mixtures thereof.

### Pharmaceutical Ingredients

The pharmaceutical ingredient can be any known agent adapted for therapeutic, prophylactic, or diagnostic use. These can include, for example, synthetic organic compounds, proteins and peptides, polysaccharides and other sugars, lipids, inorganic compounds, and nucleic acid sequences, having therapeutic, prophylactic, or diagnostic activity. Non-limiting examples of pharmaceutical ingredients include analgesics and antipyretics (e.g., acetylsalicylic acid, acetaminophen, 3-(4-isobutylphenyl)propanoic acid).

### Basic Amine

In some embodiments, the composition as disclosed herein comprises a basic amine, such as may be present in an active ingredient. By “basic amine” is meant a molecule including at least one basic amine functional group. Examples of basic amines include, but are not limited to, alkaloids. By “basic amine functional group” is meant a group containing a nitrogen atom having a lone pair of electrons. The basic amine functional group is attached to or incorporated within the molecule through one or more covalent bonds to the said nitrogen atom. The basic amine may be a primary, secondary, or tertiary amine, meaning the nitrogen bears one, two, or three covalent bonds to carbon atoms. By virtue of the lone pair of electrons on the nitrogen atom, such amines are termed “basic”, meaning the lone electron pair is available for hydrogen bonding. The basicity (i.e., the electron density on the nitrogen atom and consequently the availability and strength of hydrogen bonding to the nitrogen atom) of the basic amine may be influenced by the nature of neighboring atoms, the steric bulk of the molecule, and the like.

Generally, when present, the basic amine is released from the composition and absorbed through the oral mucosa, thereby entering the blood stream, where it is circulated systemically. Generally, the basic amine is present in or as an active ingredient in the composition, as described herein below. In some embodiments, the basic amine is nicotine or a nicotine component. By “nicotine component” is meant any suitable form of nicotine (e.g., free base, salt, or ion pair) for providing oral absorption of at least a portion of the nicotine present. Nicotine is released from the composition and absorbed through the oral mucosa, thereby entering the blood stream, where it is circulated systemically.

As described herein above, typically, the nicotine component is selected from the group consisting of nicotine free base, nicotine as an ion pair, and a nicotine salt. In some embodiments, at least a portion of the nicotine is in its free base form. In some embodiments, at least a portion of the nicotine is present as a nicotine salt, or at least a portion of the nicotine is present as an ion pair with at least a portion of an organic acid or the conjugate base thereof, as disclosed herein below.

### Ion Pairing

In some embodiments, the composition comprises a basic amine as described herein above. In some embodiments, at least a portion of the basic amine is associated with at least a portion of the organic acid or the alkali metal salt thereof, each as described herein below. The association may be in the form of a basic amine-organic acid salt, an ion pair between the basic amine and a conjugate base of the organic acid, or both. Depending on multiple variables (concentration, pH, nature of the organic acid, and the like), the basic amine present in the composition can exist in multiple forms, including ion paired, in solution (i.e., fully solvated), as the free base, as a cation, as a salt, or any combination thereof. In some embodiments, the association between the basic amine and at least a portion of the organic acid or the alkali metal salt thereof is in the form of an ion pair between the basic amine and a conjugate base of the organic acid.

Ion pairing describes the partial association of oppositely charged ions in relatively concentrated solutions to form distinct chemical species called ion pairs. The strength of the association (i.e., the ion pairing) depends on the electrostatic force of attraction between the positive and negative ions (i.e., a protonated basic amine such as nicotine, and the conjugate base of the organic acid). By “conjugate base” is meant the base resulting from deprotonation of the corresponding acid (e.g., benzoate is the conjugate base of benzoic acid). On average, a certain population of these ion pairs exists at any given time, although the formation and dissociation of ion pairs is continuous. In the oral products as disclosed herein, and/or upon oral use of said oral products (e.g., upon contact with saliva), the basic amine, for example nicotine, and the conjugate base of the organic acid exist at least partially in the form of an ion pair. Without wishing to be bound by theory, it is believed that such ion pairing may minimize chemical degradation of the basic amine and/or enhance the oral availability of the basic amine (e.g., nicotine). At alkaline pH values (e.g., such as from about 7.5 to about 9), certain basic amines, for example nicotine, are largely present in the free base form, which has relatively low water solubility, and low stability with respect to evaporation and oxidative decomposition, but high mucosal availability. Conversely, at acidic pH values (such as from about 6.5 to about 4), certain basic amines, for example nicotine, are largely present in a protonated form, which has relatively high water solubility, and higher stability with respect to evaporation and oxidative decomposition, but low mucosal availability. Surprisingly, according to the present disclosure, it has been found that the properties of stability, solubility, and availability of the nicotine in a composition configured for oral use can be mutually enhanced through ion pairing or salt formation of nicotine with appropriate organic acids and/or their conjugate bases. Specifically, nicotine-organic acid ion pairs of moderate lipophilicity result in favorable stability and absorption properties. Lipophilicity is conveniently measured in terms of log P, the partition coefficient of a molecule between a lipophilic phase and an aqueous phase, usually octanol and water, respectively. An octanol-water partitioning favoring distribution of a basic amine-organic acid ion pair into octanol is predictive of good absorption of the basic amine present in the composition through the oral mucosa.

As noted above, at alkaline pH values (e.g., such as from about 7.5 to about 9), nicotine is largely present in the free base form (and accordingly, a high partitioning into octanol), while at acidic pH values (such as from about 6.5 to about 4), nicotine is largely present in a protonated form (and accordingly, a low partitioning into octanol). Surprisingly, according to the present disclosure, it has been found that an ion pair between certain organic acids (e.g., having a log P value of from about 1.4 to about 8.0. such as from about 1.4 to about 4.5, allows nicotine partitioning into octanol consistent with that predicted for nicotine partitioning into octanol at a pH of 8.4.

One of skill in the art will recognize that the extent of ion pairing in the disclosed composition, both before and during use by the consumer, may vary based on, for example, pH, the nature of the organic acid, the concentration of basic amine, the concentration of the organic acid or conjugate base of the organic acid present in the composition, the moisture content of the composition, the ionic strength of the composition, and the like. One of skill in the art will also recognize that ion pairing is an equilibrium process influenced by the foregoing variables. Accordingly, quantification of the extent of ion pairing is difficult or impossible by calculation or direct observation. However, as disclosed herein, the presence of ion pairing may be demonstrated through surrogate measures such as partitioning of the basic amine between octanol and water or membrane permeation of aqueous solutions of the basic amine plus organic acids and/or their conjugate bases.

### Organic Acid

In some embodiments, the composition as described herein comprises an organic acid. As used herein, the term “organic acid” refers to an organic (i.e., carbon-based) compound that is characterized by acidic properties. Typically, organic acids are relatively weak acids (i.e., they do not dissociate completely in the presence of water), such as carboxylic acids (—CO₂H) or sulfonic acids (—SO₂OH). As used herein, reference to organic acid means an organic acid that is intentionally added. In this regard, an organic acid may be intentionally added as a specific composition ingredient as opposed to merely being inherently present as a component of another composition ingredient (e.g., the small amount of organic acid which may inherently be present in a composition ingredient, such as a tobacco material). As disclosed herein above, in some embodiments, at least a portion of the organic acid is present in the form of a salt or ion pair with a basic amine (e.g., nicotine).

Suitable organic acids will typically have a range of lipophilicities (i.e., a polarity giving an appropriate balance of water and organic solubility). Typically, lipophilicities of suitable organic acids, as indicated by log P, will vary between about 1 and about 12 (more soluble in octanol than in water). In some embodiments, the organic acid has a log P value of from about 3 to about 12, e.g., from about 3.0, about 3.5, about 4.0, about 4.5, about 5.0, about 5.5, about 6.0, about 6.5, about 7.0, about 7.5, or about 8.0, to about 8.5, about 9.0, about 9.5, about 10.0, about 10.5, about 11.0, about 11.5, or about 12.0. In certain embodiments, lipophilicities of suitable organic acids, as indicated by log P, will vary between about 1.4 and about 4.5 (more soluble in octanol than in water). In some embodiments, the organic acid has a log P value of from about 1.5 to about 4.0, e.g., from about 1.5, about 2.0, about 2.5, or about 3.0, to about 3.5, about 4.0, about 4.5, or about 5.0. Particularly suitable organic acids have a log P value of from about 1.7 to about 4, such as from about 2.0, about 2.5, or about 3.0, to about 3.5, or about 4.0. In specific embodiments, the organic acid has a log P value of about 2.5 to about 3.5. In some embodiments, organic acids outside this range may also be utilized for various purposes and in various amounts, as described further herein below. For example, in some embodiments, the organic acid may have a log P value of greater than about 4.5, such as from about 4.5 to about 12.0. Particularly, the presence of certain solvents or solubilizing agents (e.g., inclusion in the composition of glycerin or propylene glycol) may extend the range of lipophilicity (i.e., values of log P higher than 4.5, such as from about 4.5 to about 12.0).

In some embodiments, the organic acid is a carboxylic acid or a sulfonic acid. The carboxylic acid or sulfonic acid functional group may be attached to any alkyl, cycloalkyl, heterocycloalkyl, aryl, or heteroaryl group having, for example, from one to twenty carbon atoms (C₁-C₂₀). In some embodiments, the organic acid is an alkyl, cycloalkyl, heterocycloalkyl, aryl, or heteroaryl carboxylic or sulfonic acid.

As used herein, “alkyl” refers to any straight chain or branched chain hydrocarbon. The alkyl group may be saturated (i.e., having all sp³ carbon atoms), or may be unsaturated (i.e., having at least one site of unsaturation). As used herein, the term “unsaturated” refers to the presence of a carbon-carbon, sp² double bond in one or more positions within the alkyl group. Unsaturated alkyl groups may be mono- or polyunsaturated. Representative straight chain alkyl groups include, but are not limited to, methyl, ethyl, n-propyl, n-butyl, n-pentyl, and n-hexyl. Branched chain alkyl groups include, but are not limited to, isopropyl, sec-butyl, isobutyl, tert-butyl, isopentyl, and 2-methylbutyl. Representative unsaturated alkyl groups include, but are not limited to, ethylene or vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like. An alkyl group can be unsubstituted or substituted.

“Cycloalkyl” as used herein refers to a carbocyclic group, which may be mono- or bicyclic. Cycloalkyl groups include rings having 3 to 7 carbon atoms as a monocycle or 7 to 12 carbon atoms as a bicycle. Examples of monocyclic cycloalkyl groups include cyclopropyl, cyclobutyl, cyclopentyl, cyclohexyl, cycloheptyl, and cyclooctyl. A cycloalkyl group can be unsubstituted or substituted, and may include one or more sites of unsaturation (e.g., cyclopentenyl or cyclohexenyl).

The term “aryl” as used herein refers to a carbocyclic aromatic group. Examples of aryl groups include, but are not limited to, phenyl and naphthyl. An aryl group can be unsubstituted or substituted.

“Heteroaryl” and “heterocycloalkyl” as used herein refer to an aromatic or non-aromatic ring system, respectively, in which one or more ring atoms is a heteroatom, e.g. nitrogen, oxygen, and sulfur. The heteroaryl or heterocycloalkyl group comprises up to 20 carbon atoms and from 1 to 3 heteroatoms selected from N, O, and S. A heteroaryl or heterocycloalkyl may be a monocycle having 3 to 7 ring members (for example, 2 to 6 carbon atoms and 1 to 3 heteroatoms selected from N, O, and S) or a bicycle having 7 to 10 ring members (for example, 4 to 9 carbon atoms and 1 to 3 heteroatoms selected from N, O, and S), for example: a bicyclo[4,5], [5,5], [5,6], or [6,6] system. Examples of heteroaryl groups include by way of example and not limitation, pyridyl, thiazolyl, tetrahydrothiophenyl, pyrimidinyl, furanyl, thienyl, pyrrolyl, pyrazolyl, imidazolyl, tetrazolyl, benzofuranyl, thianaphthalenyl, indolyl, indolenyl, quinolinyl, isoquinolinyl, benzimidazolyl, isoxazolyl, pyrazinyl, pyridazinyl, indolizinyl, isoindolyl, 3H-indolyl, 1H-indazolyl, purinyl, 4H-quinolizinyl, phthalazinyl, naphthyridinyl, quinoxalinyl, quinazolinyl, cinnolinyl, pteridinyl, 4aH-carbazolyl, carbazolyl, phenanthridinyl, acridinyl, pyrimidinyl, phenanthrolinyl, phenazinyl, phenothiazinyl, furazanyl, phenoxazinyl, isochromanyl, chromanyl, imidazolidinyl, imidazolinyl, pyrazolidinyl, pyrazolinyl, benzotriazolyl, benzisoxazolyl, and isatinoyl. Examples of heterocycloalkyls include by way of example and not limitation, dihydroypyridyl, tetrahydropyridyl (piperidyl), tetrahydrothiophenyl, piperidinyl, 4-piperidonyl, pyrrolidinyl, 2-pyrrolidonyl, tetrahydrofuranyl, tetrahydropyranyl, bis-tetrahydropyranyl, tetrahydroquinolinyl, tetrahydroisoquinolinyl, decahydroquinolinyl, octahydroisoquinolinyl, piperazinyl, quinuclidinyl, and morpholinyl. Heteroaryl and heterocycloalkyl groups can be unsubstituted or substituted.

“Substituted” as used herein and as applied to any of the above alkyl, aryl, cycloalkyl, heteroaryl, heterocyclyl, means that one or more hydrogen atoms are each independently replaced with a substituent. Typical substituents include, but are not limited to, —Cl, Br, F, alkyl, —OH, —OCH₃, NH₂, —NHCH₃, —N(CH₃)₂, —CN, —NC(═O)CH₃, —C(═O)—, —C(═O)NH₂, and —C(═O)N(CH₃)₂. Wherever a group is described as “optionally substituted,” that group can be substituted with one or more of the above substituents, independently selected for each occasion. In some embodiments, the substituent may be one or more methyl groups or one or more hydroxyl groups.

In some embodiments, the organic acid is an alkyl carboxylic acid. Non-limiting examples of alkyl carboxylic acids include formic acid, acetic acid, propionic acid, butyric acid, valeric acid, caproic acid, heptanoic acid, octanoic acid, nonanoic acid, decanoic acid, undecanoic acid, dodecanoic acid, stearic acid, oleic acid, linoleic acid, linolenic acid, and the like.

In some embodiments, the organic acid is an alkyl sulfonic acid. Non-limiting examples of alkyl sulfonic acids include propanesulfonic acid, heptanesulfonic acid, and octanesulfonic acid.

In some embodiments, the alkyl carboxylic or sulfonic acid is substituted with one or more hydroxyl groups. Non-limiting examples include glycolic acid, 4-hydroxybutyric acid, and lactic acid.

In some embodiments, an organic acid may include more than one carboxylic acid group or more than one sulfonic acid group (e.g., two, three, or more carboxylic acid groups). Non-limiting examples include oxalic acid, fumaric acid, maleic acid, and glutaric acid. In organic acids containing multiple carboxylic acids (e.g., from two to four carboxylic acid groups), one or more of the carboxylic acid groups may be esterified. Non-limiting examples include succinic acid monoethyl ester, monomethyl fumarate, monomethyl or dimethyl citrate, and the like.

In some embodiments, the organic acid may include more than one carboxylic acid group and one or more hydroxyl groups. Non-limiting examples of such acids include tartaric acid, citric acid, and the like.

In some embodiments, the organic acid is an aryl carboxylic acid or an aryl sulfonic acid. Non-limiting examples of aryl carboxylic and sulfonic acids include benzoic acid, toluic acids, salicylic acid, benzenesulfonic acid, and p-toluenesulfonic acid.

Further non-limiting examples of organic acids which may be useful in certain embodiments include 2,2-dichloroacetic acid, 2-hydroxyethanesulfonic acid, 2-oxoglutaric acid, 4-acetamidobenzoic acid, 4-aminosalicylic acid, adipic acid, ascorbic acid (L), aspartic acid (L), alpha-methylbutyric acid, camphoric acid (+), camphor-10-sulfonic acid (+), cinnamic acid, cyclamic acid, dodecylsulfuric acid, ethane-1,2-disulfonic acid, ethanesulfonic acid, furoic acid, galactaric acid, gentisic acid, glucoheptonic acid, gluconic acid, glucuronic acid, glutamic acid, glycerophosphoric acid, glycolic acid, hippuric acid, isobutyric acid, isovaleric acid, lactobionic acid, lauric acid, levulinic acid, malic acid, malonic acid, mandelic acid, methanesulfonic acid, naphthalene-1,5-disulfonic acid, naphthalene-2-sulfonic acid, oleic acid, palmitic acid, pamoic acid, phenylacetic acid, pyroglutamic acid, pyruvic acid, sebacic acid, stearic acid, and undecylenic acid.

Examples of suitable acids include, but are not limited to, the list of organic acids in Table 1.

TABLE 1
Non-limiting examples of suitable organic acids

| Acid Name | log(P) |
|---|---|
| benzoic acid | 1.9 |
| phenylacetic | 1.4 |
| p-toluic acid | 2.3 |
| ethyl benzoic acid | 2.9 |
| isopropyl benzoic acid | 3.5 |
| 4-phenylbutyric | 2.4 |
| 2-napthoxyacetic acid | 2.5 |
| napthylacetic acid | 2.7 |
| heptanoic acid | 2.5 |
| octanoic acid | 3.05 |
| nonanoic acid | 3.5 |
| decanoic acid | 4.09 |
| 9-deceneoic acid | 3.3 |
| 2-deceneoic acid | 3.8 |
| 10-undecenoic acid | 3.9 |
| dodecandioic acid | 3.2 |
| dodecanoic acid | 4.6 |
| myristic acid | 5.3 |
| palmitic acid | 6.4 |
| stearic acid | 7.6 |
| cyclohexanebutanoic acid | 3.4 |
| 1-heptanesulfonic acid | 2.0 |
| 1-octanesulfonic acid | 2.5 |
| 1-nonanesulfonic acid | 3.1 |
| monooctyl succinate | 2.8 |
| tocopherol succinate | 10.2 |
| monomenthyl succinate | 3 |
| monomenthyl glutarate | 3.4 |
| norbixin | 7.2 |
| ((2E,4E,6E,8E,10E,12E,14E,16E,18E)- | |
| 4,8,13,17-tetramethylicosa- | |
| 2,4,6,8,10,12,14,16,18-nonaenedioic acid) | |

In some embodiments, the organic acid is benzoic acid, a toluic acid, benzenesulfonic acid, toluenesulfonic acid, hexanoic acid, heptanoic acid, decanoic acid, or octanoic acid. In some embodiments, the organic acid is benzoic acid, octanoic acid, or decanoic acid. In some embodiments, the organic acid is octanoic acid.

In some embodiments, the organic acid is a mono ester of a di- or poly-acid, such as mono-octyl succinate, mono-octyl fumarate, or the like. For example, the organic acid is a mono ester of a dicarboxylic acid or a poly-carboxylic acid. In some embodiments, the dicarboxylic acid is malonic acid, succinic acid, glutaric acid, adipic acid, fumaric acid, maleic acid, or a combination thereof. In some embodiments, the dicarboxylic acid is succinic acid, glutaric acid, fumaric acid, maleic acid, or a combination thereof. In some embodiments, the dicarboxylic acid is succinic acid, glutaric acid, or a combination thereof.

In some embodiments, the alcohol forming the mono ester of the dicarboxylic acid is a lipophilic alcohol. Examples of suitable lipophilic alcohols include, but are not limited to, octanol, menthol, and tocopherol. In some embodiments, the organic acid is an octyl mono ester of a dicarboxylic acid, such as monooctyl succinate, monooctyl fumarate, or the like. In some embodiments, the organic acid is a monomenthyl ester of a dicarboxylic acid. Certain menthyl esters may be desirable in oral compositions as described herein by virtue of the cooling sensation they may provide upon use of the product comprising the composition. In some embodiments, the organic acid is monomenthyl succinate, monomenthyl fumarate, monomenthyl glutarate, or a combination thereof. In some embodiments, the organic acid is a monotocopheryl ester of a dicarboxylic acid. Certain tocopheryl esters may be desirable in oral compositions as described herein by virtue of the antioxidant effects they may provide. In some embodiments, the organic acid is tocopheryl succinate, tocopheryl fumarate, tocopheryl glutarate, or a combination thereof.

In some embodiments, the organic acid is a carotenoid derivative having one or more carboxylic acids. Carotenoids are tetraterpenes, meaning that they are produced from 8 isoprene molecules and contain 40 carbon atoms. Accordingly, they are usually lipophilic due to the presence of long unsaturated aliphatic chains, and are generally yellow, orange, or red in color. Certain carotenoid derivatives can be advantageous in oral compositions by virtue of providing both ion pairing and serving as a colorant in the composition. In some embodiments, the organic acid is 2E,4E,6E,8E, 10E,12E,14E,16Z,18E)-20-methoxy-4,8,13,17-tetramethyl-20-oxoicosa-2,4,6,8,10,12,14,16,18-nonaenoic acid (bixin) or an isomer thereof. Bixin is an apocarotenoid found in annatto seeds from the achiote tree (Bixa orellana), and is the naturally occurring pigment providing the reddish orange color to annatto. Bixin is soluble in fats and alcohols but insoluble in water, and is chemically unstable when isolated, converting via isomerization into the double bond isomer, trans-bixin (β-bixin), having the structure:

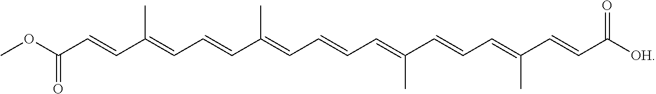 [SMILES: COC(=O)/C=C/C(C)=C/C=C/C(C)=C/C=C/C=C(C)/C=C/C=C(C)/C=C/C(=O)O]

In some embodiments, the organic acid is (2E,4E,6E,8E,10E,12E,14E,16E,18E)-4,8,13,17-tetramethylicosa-2,4,6,8,10,12,14,16,18-nonaenedioic acid (norbixin), a water soluble hydrolysis product of bixin having the structure:

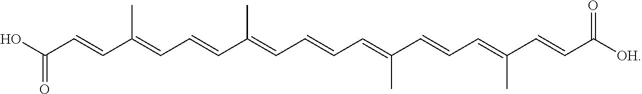 [SMILES: CC(/C=C/C=C(C)/C=C/C(=O)O)=C\C=C\C=C(C)\C=C\C=C(C)\C=C\C(=O)O]

The selection of organic acid may further depend on additional properties in addition to or without consideration to the log P value. For example, an organic acid should be one recognized as safe for human consumption, and which has acceptable flavor, odor, volatility, stability, and the like. Determination of appropriate organic acids is within the purview of one of skill in the art.

In some embodiments, more than one organic acid may be present. For example, the composition may comprise two, or three, or four, or more organic acids. Accordingly, reference herein to “an organic acid” contemplates mixtures of two or more organic acids. The relative amounts of the multiple organic acids may vary. For example, a composition may comprise equal amounts of two, or three, or more organic acids, or may comprise different relative amounts. In this manner, it is possible to include certain organic acids (e.g., citric acid or myristic acid) which have a log P value outside the desired range, when combined with other organic acids to provide the desired average log P range for the combination. In some embodiments, it may be desirable to include organic acids in the composition which have log P values outside the desired range for purposes such as, but not limited to, providing desirable organoleptic properties, stability, as flavor components, and the like. Further, certain lipophilic organic acids have undesirable flavor and or aroma characteristics which would preclude their presence as the sole organic acid (e.g., in equimolar or greater quantities relative to a basic amine containing active ingredient, such as nicotine). Without wishing to be bound by theory, it is believed that a combination of different organic acids may provide the desired attributes to the composition, while the concentration of any single organic acid in the composition remains below the threshold which would be found objectionable from a sensory perspective.

For example, in some embodiments, the organic acid may comprise from about 1 to about 5 or more molar equivalents of benzoic acid relative to a basic amine-containing active ingredient (e.g., nicotine), combined with e.g., about 0.2 molar equivalents of octanoic acid or a salt thereof, and 0.2 molar equivalents of decanoic acid or a salt thereof.

In some embodiments, the organic acid is a combination of any two organic acids selected from the group consisting of benzoic acid, a toluic acid, benzenesulfonic acid, toluenesulfonic acid, hexanoic acid, heptanoic acid, decanoic acid, and octanoic acid. In some embodiments, the organic acid is a combination of benzoic acid, octanoic acid, and decanoic acid, or benzoic and octanoic acid. In some embodiments, the composition comprises citric acid in addition to one or more of benzoic acid, a toluic acid, benzenesulfonic acid, toluenesulfonic acid, hexanoic acid, heptanoic acid, decanoic acid, and octanoic acid.

In some embodiments, the composition comprises an alkali metal salt of an organic acid. For example, at least a portion of the organic acid may be present in the composition in the form of an alkali metal salt. Suitable alkali metal salts include lithium, sodium, and potassium. In some embodiments, the alkali metal is sodium or potassium. In some embodiments, the alkali metal is sodium. In some embodiments, the composition comprises an organic acid and a sodium salt of the organic acid.

In some embodiments, the composition comprises benzoic acid and sodium benzoate, octanoic acid and sodium octanoate, decanoic acid and sodium decanoate, or a combination thereof. In some embodiments, the composition comprises benzoic acid and sodium benzoate.

In some embodiments, the ratio of the organic acid to the sodium salt of the organic acid is from about 0.1 to about 10, such as from about 0.1, about 0.25, about 0.3, about 0.5, about 0.75, or about 1, to about 2, about 5, or about 10. For example, in some embodiments, both an organic acid and the sodium salt thereof are added to the other components of the composition, wherein the organic acid is added in excess of the sodium salt, in equimolar quantities with the sodium salt, or as a fraction of the sodium salt. One of skill in the art will recognize that the relative amounts will be determined by the desired pH of the composition, as well as the desired ionic strength. For example, the organic acid may be added in a quantity to provide a desired pH level of the composition, while the alkali metal (e.g., sodium) salt is added in a quantity to provide the desired extent of ion pairing. As one of skill in the art will understand, the quantity of organic acid (i.e., the protonated form) present in the composition, relative to the alkali metal salt or conjugate base form present in the composition, will vary according to the pH of the composition and the pKa of the organic acid, as well as according to the actual relative quantities initially added to the composition.

The amount of organic acid or an alkali metal salt thereof present in the composition, relative to a basic amine-containing active ingredient (e.g., nicotine) may vary. Generally, as the concentration of the organic acid (or the conjugate base thereof) increases, the percent of basic amine-containing active ingredient (e.g., nicotine) that is ion paired with the organic acid increases. This typically increases the partitioning of the basic amine-containing active ingredient (e.g., nicotine), in the form of an ion pair, into octanol versus water as measured by the log P (the log₁₀ of the partitioning coefficient). In some embodiments, the composition comprises from about 0.05, about 0.1, about 1, about 1.5, about 2, or about 5, to about 10, about 15, or about 20 molar equivalents of the organic acid, the alkali metal salt thereof, or the combination thereof, relative to the basic amine-containing active ingredient (e.g., nicotine), calculated as the free base amine-containing active ingredient.

In some embodiments, the composition comprises from about 2 to about 10, or from about 2 to about 5 molar equivalents of the organic acid, the alkali metal salt thereof, or the combination thereof, to nicotine, on a free-base nicotine basis. In some embodiments, the organic acid, the alkali metal salt thereof, or the combination thereof, is present in a molar ratio with the nicotine from about 2, about 3, about 4, or about 5, to about 6, about 7, about 8, about 9, or about 10. In embodiments wherein more than one organic acid, alkali metal salt thereof, or both, are present, it is to be understood that such molar ratios reflect the totality of the organic acids present.

In certain embodiments the organic acid inclusion is sufficient to provide a composition pH of from about 4.0 to about 9.5, such as from about 4.0 to about 9.0, or from about 4.0 to about 8.5, or from about 4.0 to about 8.0, or from about 4.5 to about 7.5, or from about 4.5 to about 7.0, or from about 5.5 to about 7.0, or from about 4.0 to about 5.5, or from about 7.0 to about 9.5. In some embodiments, the organic acid inclusion is sufficient to provide a composition pH of about 4.0, about 4.5, about 5.0, about 5.5, about 6.0, about 6.5, about 7.0, about 7.5, about 8.0, about 8.5, or about 9.0. In some embodiments, the organic acid inclusion is sufficient to provide a composition pH of from about 4.5 to about 6.5, for example, from about 4.5, about 5.0, or about 5.5, to about 6.0, or about 6.5. In some embodiments, the organic acid is provided in a quantity sufficient to provide a pH of the composition of from about 5.5 to about 6.5, for example, from about 5.5, about 5.6, about 5.7, about 5.8, about 5.9, or about 6.0, to about 6.1, about 6.2, about 6.3, about 6.4, or about 6.5. In other embodiments, a mineral acid (e.g., hydrochloric acid, sulfuric acid, phosphoric acid, or the like) is added to adjust the pH of the composition to the desired value.

In some embodiments, the organic acid is added as the free acid, either neat (i.e., native solid or liquid form) or as a solution in, e.g., water, to the other composition components. In some embodiments, the alkali metal salt of the organic acid is added, either neat or as a solution in, e.g., water, to the other composition components. In some embodiments, the organic acid and the amine-containing active ingredient (e.g., nicotine) are combined to form a salt, either before addition to the composition, or the salt is formed within and is present in the composition as such. In other embodiments, the organic acid and amine-containing active ingredient (e.g., nicotine) are present as individual components in the composition, and form an ion pair upon contact with moisture (e.g., saliva in the mouth of the consumer).

In some embodiments, the composition further comprises a solubility enhancer to increase the solubility of one or more of the organic acid or salt thereof. Suitable solubility enhancers include, but are not limited to, humectants as described herein such as glycerol or propylene glycol.

### Bleached Active Ingredient

In some embodiments, the composition comprises an active ingredient as disclosed herein, wherein the active ingredient is characterized as bleached. Such a bleached active ingredient may be desirable e.g., to prevent tooth discoloration during use of the oral product, or so that any residue remaining in the mouth of the user after use of the product is less visible, and is less likely to cause staining of fibrous materials, such as clothing, that may contact the residue. By “bleached” active ingredient is meant an active ingredient (e.g., a botanical material or derivative thereof), which, in its natural state possesses a color, and which has been treated to reduce or eliminate the color. By “color” is meant the characteristic of human visual perception described through color categories, with names such as red, blue, yellow (primary colors) or brown, orange, green, purple, and the like, resulting from combinations of primary colors. This perception of color derives from the stimulation of cone cells in the human eye by electromagnetic radiation in the visible spectrum, associated with objects through the wavelength of the light that is reflected from them. This reflection is governed by the object's physical properties such as e.g., absorption and emission spectra across the electromagnetic spectrum.

Certain active ingredients, by virtue of naturally occurring chemical compounds therein which reflect light in the visible range of the electromagnetic spectrum, impart a color to the active ingredient (e.g., chlorophyll or pigment decomposition products in certain botanical materials, responsible for green color and brown colors, respectively). Such chemical compounds, or a portion thereof, which are responsible for the color of the active ingredient, may be chemically altered or removed by various treatments. In some embodiments, the treatment is effective to eliminate at least 70% of the chemicals present in the active ingredient having maximum transmission of wavelengths in the visible range of the electromagnetic spectrum, based on the weight of the naturally occurring compounds. For example, such treatment may be effective to remove 70%, 80%, 90%, 95%, 99%, or even 100% of the naturally occurring compounds responsible for the visible color of the active ingredient.

In some embodiments, the treatment for bleaching (i.e., altering or removing colored chemical compounds from the active ingredient) includes extraction, chemical bleaching, or a combination thereof. One particularly suitable extraction method is supercritical carbon dioxide (CO₂) extraction. Methods of chemical bleaching of e.g., botanical materials, including tobacco, are known, and include as non-limiting examples, treatment with hydrogen peroxide, ozone, or other oxidizing agents. For example, bleached active ingredients (e.g., a bleached botanical or tobacco material) may be produced by various whitening methods using various bleaching or oxidizing agents. Example oxidizing agents include peroxides (e.g., hydrogen peroxide), chlorite salts, chlorate salts, perchlorate salts, hypochlorite salts, ozone, ammonia, potassium permanganate, and combinations thereof. Oxidation catalysts can be used. Example oxidation catalysts are titanium dioxide, manganese dioxide, and combinations thereof.

Methods of bleaching known for bleaching tobacco may be applied to the present active ingredients. Processes for treating tobacco with bleaching agents are discussed, for example, in U.S. Pat. No. 787,611 to Daniels, Jr.; U.S. Pat. No. 1,086,306 to Oelenheinz; U.S. Pat. No. 1,437,095 to Delling; U.S. Pat. No. 1,757,477 to Rosenhoch; U.S. Pat. No. 2,122,421 to Hawkinson; U.S. Pat. No. 2,148,147 to Baier; U.S. Pat. No. 2,170,107 to Baier; U.S. Pat. No. 2,274,649 to Baier; U.S. Pat. No. 2,770,239 to Prats et al.; U.S. Pat. No. 3,612,065 to Rosen; U.S. Pat. No. 3,851,653 to Rosen; U.S. Pat. No. 3,889,689 to Rosen; U.S. Pat. No. 3,943,940 to Minami; U.S. Pat. No. 3,943,945 to Rosen; U.S. Pat. No. 4,143,666 to Rainer; U.S. Pat. No. 4,194,514 to Campbell; U.S. Pat. Nos. 4,366,823, 4,366,824, and 4,388,933 to Rainer et al.; U.S. Pat. No. 4,641,667 to Schmekel et al.; U.S. Pat. No. 5,713,376 to Berger; U.S. Pat. No. 9,339,058 to Byrd Jr. et al.; U.S. Pat. No. 9,420,825 to Beeson et al.; and U.S. Pat. No. 9,950,858 to Byrd Jr. et al.; as well as in US Pat. App. Pub. Nos. 2012/0067361 to Bjorkholm et al.; 2016/0073686 to Crooks; 2017/0020183 to Bjorkholm; and 2017/0112183 to Bjorkholm, and in PCT Publ. Appl. Nos. WO1996/031255 to Giolvas and WO2018/083114 to Bjorkholm, all of which are incorporated herein by reference.

In some embodiments, the bleached active agent, or the composition or product comprising the bleached active agent, can have an ISO brightness of at least about 50%, at least about 60%, at least about 65%, at least about 70%, at least about 75%, or at least about 80%. In some embodiments, the bleached active agent or the composition or product comprising the bleached active agent, can have an ISO brightness in the range of about 50% to about 90%, about 55% to about 75%, or about 60% to about 70%. ISO brightness can be measured according to ISO 3688:1999 or ISO 2470-1:2016.

In some embodiments, the bleached active agent can be characterized as lightened in color (e.g., “whitened”) in comparison to an untreated active agent. White colors are often defined with reference to the International Commission on Illumination's (CIE's) chromaticity diagram. The bleached active agent or the composition or product comprising the bleached active agent, can, in certain embodiments, be characterized as closer on the chromaticity diagram to pure white than an untreated active agent or composition or product comprising an untreated active agent.

Whiteness values of bleached active ingredients, compositions, and pouched products comprising such ingredients, may be determined according to the Commission Internationale de l'Eclairage (CIE) model, for example, with a hand-held color meter, relative to a control product (See “Precise Color Communication; Color Control from Perception to Instrumentation,” Konica Minolta, 2007; http://konicaminolta.com/instruments/about/network, which is incorporated herein by reference). Discoloration from white may be evaluated by the E313 Whiteness Index according to ASTM method E313, using the formula WI=(3.388Z-3Y, where Y and Z are the CIE tri-stimulus values, and measured by a hand-held meter.

### Flavoring Agents

In some embodiments, the composition comprises a flavoring agent. As used herein, a “flavoring agent” or “flavorant” is any flavorful or aromatic substance capable of altering the sensory characteristics associated with the oral product. Examples of sensory characteristics that can be modified by the flavoring agent include taste, mouthfeel, moistness, coolness/heat, and/or fragrance/aroma. Flavoring agents may be natural or synthetic, and the character of the flavors imparted thereby may be described, without limitation, as fresh, sweet, herbal, confectionary, floral, fruity, or spicy. Specific types of flavors include, but are not limited to, vanilla, coffee, chocolate/cocoa, cream, mint, spearmint, menthol, peppermint, wintergreen, eucalyptus, lavender, cardamon, nutmeg, cinnamon, clove, cascarilla, sandalwood, honey, jasmine, ginger, anise, sage, licorice, lemon, orange, apple, peach, lime, cherry, strawberry, trigeminal sensates, terpenes and any combinations thereof. See also, Leffingwell et al., Tobacco Flavoring for Smoking Products, R. J. Reynolds Tobacco Company (1972), which is incorporated herein by reference. Flavoring agents also may include components that are considered moistening, cooling or smoothening agents, such as eucalyptus. These flavors may be provided neat (i.e., alone) or in a composite, and may be employed as concentrates or flavor packages (e.g., spearmint and menthol, orange and cinnamon; lime, pineapple, and the like). Representative types of components also are set forth in U.S. Pat. No. 5,387,416 to White et al.; US Pat. App. Pub. No. 2005/0244521 to Strickland et al.; and PCT Application Pub. No. WO 05/041699 to Quinter et al., each of which is incorporated herein by reference. In some instances, the flavoring agent may be provided in a spray-dried form or a liquid form.

The amount of flavoring agent utilized in the composition can vary, but is typically up to about 10% by weight, and certain embodiments are characterized by a flavoring agent content of at least about 0.1% by weight, such as about 0.5 to about 10%, about 1 to about 5%, or about 2 to about 4% weight, based on the total weight of the composition.

### Taste Modifiers

In order to improve the organoleptic properties of a composition as disclosed herein, the composition may include one or more taste modifying agents (“taste modifiers”) which may serve to mask, alter, block, or improve e.g., the flavor of a composition as described herein. Non-limiting examples of such taste modifiers include analgesic or anesthetic herbs, spices, and flavors which produce a perceived cooling (e.g., menthol, eucalyptus, mint), warming (e.g., cinnamon), or painful (e.g., capsaicin) sensation. Certain taste modifiers fall into more than one overlapping category.

In some embodiments, the taste modifier modifies one or more of bitter, sweet, salty, or sour tastes. In some embodiments, the taste modifier targets pain receptors. In some embodiments, the composition comprises an active ingredient having a bitter taste, and a taste modifier which masks or blocks the perception of the bitter taste. In some embodiments, the taste modifier is a substance which targets pain receptors (e.g., vanilloid receptors) in the user's mouth to mask e.g., a bitter taste of another component (e.g., an active ingredient). In some embodiments, the taste modifier is capsaicin.

In some embodiments, the taste modifier is the amino acid gamma-amino butyric acid (GABA), referenced herein above with respect to amino acids. Studies in mice suggest that GABA may serve function(s) in taste buds in addition to synaptic inhibition. See, e.g., Dvoryanchikov et al., J Neurosci. 2011 Apr. 13; 31(15):5782-91. Without wishing to be bound by theory, GABA may suppress the perception of certain tastes, such as bitterness. In some embodiments, the composition comprises caffeine and GABA.

In some embodiments, the taste modifier is adenosine monophosphate (AMP). AMP is a naturally occurring nucleotide substance which can block bitter food flavors or enhance sweetness. It does not directly alter the bitter flavor, but may alter human perception of “bitter” by blocking the associated receptor.

In some embodiments, the taste modifier is lactisole. Lactisole is an antagonist of sweet taste receptors. Temporarily blocking sweetness receptors may accentuate e.g., savory notes.

When present, a representative amount of taste modifier is about 0.01% by weight or more, about 0.1% by weight or more, or about 1.0% by weight or more, but will typically make up less than about 10% by weight of the total weight of the composition, (e.g., from about 0.01%, about 0.05%, about 0.1%, or about 0.5%, to about 1%, about 5%, or about 10% by weight of the total weight of the composition).

### Salts

In some embodiments, the composition comprises a salt (e.g., an alkali metal salt), typically employed in an amount sufficient to provide desired sensory attributes to the composition. Non-limiting examples of suitable salts include sodium chloride, potassium chloride, ammonium chloride, flour salt, sodium acetate, sodium citrate, and the like. In some embodiments, the salt is sodium chloride, ammonium chloride, or a combination thereof.

When present, a representative amount of salt is about 0.5% by weight or more, about 1.0% by weight or more, or about 1.5% by weight or more, but will typically make up about 10% or less of the total weight of the composition, or about 7.5% or less, or about 5% or less (e.g., from about 0.5 to about 5% by weight).

### Sweeteners

In order to improve the sensory properties of the composition according to the disclosure, one or more sweeteners may be added. The sweeteners can be any sweetener or combination of sweeteners, in natural or artificial form, or as a combination of natural and artificial sweeteners. Examples of natural sweeteners include fructose, sucrose, glucose, maltose, isomaltulose, mannose, galactose, lactose, stevia, honey, and the like. Examples of artificial sweeteners include sucralose, maltodextrin, saccharin, aspartame, acesulfame K, neotame, and the like. In some embodiments, the sweetener comprises one or more sugar alcohols. Sugar alcohols are polyols derived from monosaccharides or disaccharides that have a partially or fully hydrogenated form. Sugar alcohols have, for example, about 4 to about 20 carbon atoms and include erythritol, arabitol, ribitol, isomalt, maltitol, dulcitol, iditol, mannitol, xylitol, lactitol, sorbitol, and combinations thereof (e.g., hydrogenated starch hydrolysates). In some embodiments, the sweetener is xylitol, sucralose, or a combination thereof.

When present, a sweetener or combination of sweeteners may make up from about 0.1 to about 20% or more of the of the composition by weight, for example, from about 0.1 to about 1%, from about 1 to about 5%, from about 5 to about 10%, or from about 10 to about 20% by weight, based on the total weight of the composition. In some embodiments, a combination of sweeteners is present at a concentration of from about 1% to about 3% by weight of the composition.

### Water

The water content of the composition, prior to use by a consumer of the pouched product, may vary according to the desired properties. Typically, the composition is less than about 15% by weight of water, and generally is from about 0.1 to about 10% by weight of water, for example, from about 0.1 to about 1, about 1 to about 10, or about 1 to about 5% by weight, based on the total weight of the composition.

### Buffering Agents

In certain embodiments, the composition of the present disclosure can comprise pH adjusters or buffering agents. Examples of pH adjusters and buffering agents that can be used include, but are not limited to, metal hydroxides (e.g., alkali metal hydroxides such as sodium hydroxide and potassium hydroxide), and other alkali metal buffers such as metal carbonates (e.g., potassium carbonate or sodium carbonate), or metal bicarbonates such as sodium bicarbonate, and the like. Non-limiting examples of suitable buffers include alkali metals acetates, glycinates, phosphates, glycerophosphates, citrates, carbonates, hydrogen carbonates, borates, or mixtures thereof. In some embodiments, the buffer is sodium bicarbonate.

Where present, the buffering agent is typically present in an amount less than about 5% by weight, based on the weight of the composition, for example, from about 0.1% to about 5%, such as, e.g., from about 0.1% to about 1%, or from about 0.1% to about 0.5% by weight, based on the total weight of the composition.

### Colorants

A colorant may be employed in amounts sufficient to provide the desired physical attributes to the composition. Examples of colorants include various dyes and pigments, such as caramel coloring and titanium dioxide. The amount of colorant utilized in the composition can vary, but when present is typically up to about 3% by weight, such as from about 0.1%, about 0.5%, or about 1%, to about 3% by weight, based on the total weight of the composition.

### Humectants

In certain embodiments, one or more humectants may be employed in the composition. Examples of humectants include, but are not limited to, glycerin, propylene glycol, and the like. Where included, the humectant is typically provided in an amount sufficient to provide desired moisture attributes to the composition. Further, in some instances, the humectant may impart desirable flow characteristics to the composition for depositing in a mold. In some embodiments, the humectant is propylene glycol.

When present, a humectant will typically make up about 5% or less of the weight of the composition (e.g., from about 0.1 to about 5% by weight), for example, from about 0.1% to about 1% by weight, or about 1% to about 5% by weight, based on the total weight of the composition.

### Tobacco Material

In some embodiments, the composition may include a tobacco material. The tobacco material can vary in species, type, and form. Generally, the tobacco material is obtained from for a harvested plant of the Nicotiana species. Example Nicotiana species include N. tabacum, N. rustica, N. alata, N. arentsii, N. excelsior, N. forgetiana, N. glauca, N. glutinosa, N. gossei, N. kawakamii, N. knightiana, N. langsdorffi, N. otophora, N. setchelli, N. sylvestris, N. tomentosa, N. tomentosiformis, N. undulata, N. x sanderae, N. africana, N. amplexicaulis, N. benavidesii, N. bonariensis, N. debneyi, N. longiflora, N. maritina, N. megalosiphon, N. occidentalis, N. paniculata, N. plumbaginifolia, N. raimondii, N. rosulata, N. simulans, N. stocktonii, N. suaveolens, N. umbratica, N. velutina, N. wigandioides, N. acaulis, N. acuminata, N. attenuata, N. benthamiana, N. cavicola, N. clevelandii, N. cordifolia, N. corymbosa, N. fragrans, N. goodspeedii, N. linearis, N. miersii, N. nudicaulis, N. obtusifolia, N. occidentalis subsp. Hersperis, N. pauciflora, N. petunioides, N. quadrivalvis, N. repanda, N. rotundifolia, N. solanifolia, and N. spegazzinii. Various representative other types of plants from the Nicotiana species are set forth in Goodspeed, The Genus Nicotiana, (Chonica Botanica) (1954); U.S. Pat. No. 4,660,577 to Sensabaugh, Jr. et al.; U.S. Pat. No. 5,387,416 to White et al., U.S. Pat. No. 7,025,066 to Lawson et al.; U.S. Pat. No. 7,798,153 to Lawrence, Jr. and U.S. Pat. No. 8,186,360 to Marshall et al.; each of which is incorporated herein by reference. Descriptions of various types of tobaccos, growing practices and harvesting practices are set forth in Tobacco Production, Chemistry and Technology, Davis et al. (Eds.) (1999), which is incorporated herein by reference.

Nicotiana species from which suitable tobacco materials can be obtained can be derived using genetic-modification or crossbreeding techniques (e.g., tobacco plants can be genetically engineered or crossbred to increase or decrease production of components, characteristics or attributes). See, for example, the types of genetic modifications of plants set forth in U.S. Pat. No. 5,539,093 to Fitzmaurice et al.; U.S. Pat. No. 5,668,295 to Wahab et al.; U.S. Pat. No. 5,705,624 to Fitzmaurice et al.; U.S. Pat. No. 5,844,119 to Weigl; U.S. Pat. No. 6,730,832 to Dominguez et al.; U.S. Pat. No. 7,173,170 to Liu et al.; U.S. Pat. No. 7,208,659 to Colliver et al. and U.S. Pat. No. 7,230,160 to Benning et al.; US Patent Appl. Pub. No. 2006/0236434 to Conkling et al.; and PCT WO2008/103935 to Nielsen et al. See, also, the types of tobaccos that are set forth in U.S. Pat. No. 4,660,577 to Sensabaugh, Jr. et al.; U.S. Pat. No. 5,387,416 to White et al.; and U.S. Pat. No. 6,730,832 to Dominguez et al., each of which is incorporated herein by reference.

The Nicotiana species can, in some embodiments, be selected for the content of various compounds that are present therein. For example, plants can be selected on the basis that those plants produce relatively high quantities of one or more of the compounds desired to be isolated therefrom. In certain embodiments, plants of the Nicotiana species (e.g., Galpao commun tobacco) are specifically grown for their abundance of leaf surface compounds. Tobacco plants can be grown in greenhouses, growth chambers, or outdoors in fields, or grown hydroponically.

Various parts or portions of the plant of the Nicotiana species can be included within a composition as disclosed herein. For example, virtually all of the plant (e.g., the whole plant) can be harvested, and employed as such. Alternatively, various parts or pieces of the plant can be harvested or separated for further use after harvest. For example, the flower, leaves, stem, stalk, roots, seeds, and various combinations thereof, can be isolated for further use or treatment. In some embodiments, the tobacco material comprises tobacco leaf (lamina). The composition disclosed herein can include processed tobacco parts or pieces, cured and aged tobacco in essentially natural lamina and/or stem form, a tobacco extract, extracted tobacco pulp (e.g., using water as a solvent), or a mixture of the foregoing (e.g., a mixture that combines extracted tobacco pulp with granulated cured and aged natural tobacco lamina).

In certain embodiments, the tobacco material comprises solid tobacco material selected from the group consisting of lamina and stems. The tobacco that is used for the mixture most preferably includes tobacco lamina, or a tobacco lamina and stem mixture (of which at least a portion is smoke-treated). Portions of the tobaccos within the mixture may have processed forms, such as processed tobacco stems (e.g., cut-rolled stems, cut-rolled-expanded stems or cut-puffed stems), or volume expanded tobacco (e.g., puffed tobacco, such as dry ice expanded tobacco (DIET)). See, for example, the tobacco expansion processes set forth in U.S. Pat. No. 4,340,073 to de la Burde et al.; U.S. Pat. No. 5,259,403 to Guy et al.; and U.S. Pat. No. 5,908,032 to Poindexter, et al.; and U.S. Pat. No. 7,556,047 to Poindexter, et al., all of which are incorporated by reference. In addition, the d mixture optionally may incorporate tobacco that has been fermented. See, also, the types of tobacco processing techniques set forth in PCT WO2005/063060 to Atchley et al., which is incorporated herein by reference.

The tobacco material is typically used in a form that can be described as particulate (i.e., shredded, ground, granulated, or powder form). The manner by which the tobacco material is provided in a finely divided or powder type of form may vary. Preferably, plant parts or pieces are comminuted, ground or pulverized into a particulate form using equipment and techniques for grinding, milling, or the like. Most preferably, the plant material is relatively dry in form during grinding or milling, using equipment such as hammer mills, cutter heads, air control mills, or the like. For example, tobacco parts or pieces may be ground or milled when the moisture content thereof is less than about 15% by weight, or less than about % by weight. Most preferably, the tobacco material is employed in the form of parts or pieces that have an average particle size between 1.4 millimeters and 250 microns. In some instances, the tobacco particles may be sized to pass through a screen mesh to obtain the particle size range required. If desired, air classification equipment may be used to ensure that small sized tobacco particles of the desired sizes, or range of sizes, may be collected. If desired, differently sized pieces of granulated tobacco may be mixed together.

The manner by which the tobacco is provided in a finely divided or powder type of form may vary. Preferably, tobacco parts or pieces are comminuted, ground or pulverized into a powder type of form using equipment and techniques for grinding, milling, or the like. Most preferably, the tobacco is relatively dry in form during grinding or milling, using equipment such as hammer mills, cutter heads, air control mills, or the like. For example, tobacco parts or pieces may be ground or milled when the moisture content thereof is less than about 15% by weight to less than about 5% by weight. For example, the tobacco plant or portion thereof can be separated into individual parts or pieces (e.g., the leaves can be removed from the stems, and/or the stems and leaves can be removed from the stalk). The harvested plant or individual parts or pieces can be further subdivided into parts or pieces (e.g., the leaves can be shredded, cut, comminuted, pulverized, milled or ground into pieces or parts that can be characterized as filler-type pieces, granules, particulates or fine powders). The plant, or parts thereof, can be subjected to external forces or pressure (e.g., by being pressed or subjected to roll treatment). When carrying out such processing conditions, the plant or portion thereof can have a moisture content that approximates its natural moisture content (e.g., its moisture content immediately upon harvest), a moisture content achieved by adding moisture to the plant or portion thereof, or a moisture content that results from the drying of the plant or portion thereof. For example, powdered, pulverized, ground or milled pieces of plants or portions thereof can have moisture contents of less than about 25% by weight, often less than about 20%, and frequently less than about 15% by weight.

For the preparation of oral products, it is typical for a harvested plant of the Nicotiana species to be subjected to a curing process. The tobacco materials incorporated within the mixture for inclusion within products as disclosed herein are those that have been appropriately cured and/or aged. Descriptions of various types of curing processes for various types of tobaccos are set forth in Tobacco Production, Chemistry and Technology, Davis et al. (Eds.) (1999). Examples of techniques and conditions for curing flue-cured tobacco are set forth in Nestor et al., Beitrage Tabakforsch. Int., 20, 467-475 (2003) and U.S. Pat. No. 6,895,974 to Peele, which are incorporated herein by reference. Representative techniques and conditions for air curing tobacco are set forth in U.S. Pat. No. 7,650,892 to Groves et al.; Roton et al., Beitrage Tabakforsch. Int., 21, 305-320 (2005) and Staaf et al., Beitrage Tabakforsch. Int., 21, 321-330 (2005), which are incorporated herein by reference. Certain types of tobaccos can be subjected to alternative types of curing processes, such as fire curing or sun curing.

In certain embodiments, tobacco materials that can be employed include flue-cured or Virginia (e.g., K326), burley, sun-cured (e.g., Indian Kurnool and Oriental tobaccos, including Katerini, Prelip, Komotini, Xanthi and Yambol tobaccos), Maryland, dark, dark-fired, dark air cured (e.g., Madole, Passanda, Cubano, Jatin and Bezuki tobaccos), light air cured (e.g., North Wisconsin and Galpao tobaccos), Indian air cured, Red Russian and Rustica tobaccos, as well as various other rare or specialty tobaccos and various blends of any of the foregoing tobaccos.

The tobacco material may also have a so-called “blended” form. For example, the tobacco material may include a mixture of parts or pieces of flue-cured, burley (e.g., Malawi burley tobacco) and Oriental tobaccos (e.g., as tobacco composed of, or derived from, tobacco lamina, or a mixture of tobacco lamina and tobacco stem). For example, a representative blend may incorporate about 30 to about 70 parts burley tobacco (e.g., lamina, or lamina and stem), and about 30 to about 70 parts flue cured tobacco (e.g., stem, lamina, or lamina and stem) on a dry weight basis. Other example tobacco blends incorporate about 75 parts flue-cured tobacco, about 15 parts burley tobacco, and about 10 parts Oriental tobacco; or about 65 parts flue-cured tobacco, about 25 parts burley tobacco, and about 10 parts Oriental tobacco; or about 65 parts flue-cured tobacco, about 10 parts burley tobacco, and about 25 parts Oriental tobacco; on a dry weight basis. Other example tobacco blends incorporate about 20 to about 30 parts Oriental tobacco and about 70 to about 80 parts flue-cured tobacco on a dry weight basis.

Tobacco materials used in the present disclosure can be subjected to, for example, fermentation, bleaching, and the like. If desired, the tobacco materials can be, for example, irradiated, pasteurized, or otherwise subjected to controlled heat treatment. Such treatment processes are detailed, for example, in U.S. Pat. No. 8,061,362 to Mua et al., which is incorporated herein by reference. In certain embodiments, tobacco materials can be treated with water and an additive capable of inhibiting reaction of asparagine to form acrylamide upon heating of the tobacco material (e.g., an additive selected from the group consisting of lysine, glycine, histidine, alanine, methionine, cysteine, glutamic acid, aspartic acid, proline, phenylalanine, valine, arginine, compositions incorporating di- and trivalent cations, asparaginase, certain non-reducing saccharides, certain reducing agents, phenolic compounds, certain compounds having at least one free thiol group or functionality, oxidizing agents, oxidation catalysts, natural plant extracts (e.g., rosemary extract), and combinations thereof. See, for example, the types of treatment processes described in U.S. Pat. Nos. 8,434,496, 8,944,072, and 8,991,403 to Chen et al., which are all incorporated herein by reference. In certain embodiments, this type of treatment is useful where the original tobacco material is subjected to heat in the processes previously described.

In various embodiments, the tobacco material can be treated to extract a soluble component of the tobacco material therefrom. “Tobacco extract” as used herein refers to the isolated components of a tobacco material that are extracted from solid tobacco pulp by a solvent that is brought into contact with the tobacco material in an extraction process. Various extraction techniques of tobacco materials can be used to provide a tobacco extract and tobacco solid material. See, for example, the extraction processes described in US Pat. Appl. Pub. No. 2011/0247640 to Beeson et al., which is incorporated herein by reference. Other example techniques for extracting components of tobacco are described in U.S. Pat. No. 4,144,895 to Fiore; U.S. Pat. No. 4,150,677 to Osborne, Jr. et al.; U.S. Pat. No. 4,267,847 to Reid; U.S. Pat. No. 4,289,147 to Wildman et al.; U.S. Pat. No. 4,351,346 to Brummer et al.; U.S. Pat. No. 4,359,059 to Brummer et al.; U.S. Pat. No. 4,506,682 to Muller; U.S. Pat. No. 4,589,428 to Keritsis; U.S. Pat. No. 4,605,016 to Soga et al.; U.S. Pat. No. 4,716,911 to Poulose et al.; U.S. Pat. No. 4,727,889 to Niven, Jr. et al.; U.S. Pat. No. 4,887,618 to Bernasek et al.; U.S. Pat. No. 4,941,484 to Clapp et al.; U.S. Pat. No. 4,967,771 to Fagg et al.; U.S. Pat. No. 4,986,286 to Roberts et al.; U.S. Pat. No. 5,005,593 to Fagg et al.; U.S. Pat. No. 5,018,540 to Grubbs et al.; U.S. Pat. No. 5,060,669 to White et al.; U.S. Pat. No. 5,065,775 to Fagg; U.S. Pat. No. 5,074,319 to White et al.; U.S. Pat. No. 5,099,862 to White et al.; U.S. Pat. No. 5,121,757 to White et al.; U.S. Pat. No. 5,131,414 to Fagg; U.S. Pat. No. 5,131,415 to Munoz et al.; U.S. Pat. No. 5,148,819 to Fagg; U.S. Pat. No. 5,197,494 to Kramer; U.S. Pat. No. 5,230,354 to Smith et al.; U.S. Pat. No. 5,234,008 to Fagg; U.S. Pat. No. 5,243,999 to Smith; U.S. Pat. No. 5,301,694 to Raymond et al.; U.S. Pat. No. 5,318,050 to Gonzalez-Parra et al.; U.S. Pat. No. 5,343,879 to Teague; U.S. Pat. No. 5,360,022 to Newton; U.S. Pat. No. 5,435,325 to Clapp et al.; U.S. Pat. No. 5,445,169 to Brinkley et al.; U.S. Pat. No. 6,131,584 to Lauterbach; U.S. Pat. No. 6,298,859 to Kierulff et al.; U.S. Pat. No. 6,772,767 to Mua et al.; and U.S. Pat. No. 7,337,782 to Thompson, all of which are incorporated by reference herein.

In some embodiments, the type of tobacco material is selected such that it is initially visually lighter in color than other tobacco materials to some degree (e.g., whitened or bleached). Tobacco pulp can be whitened in certain embodiments according to any means known in the art, and as described above in reference to color-eliminated active ingredients.

Typical inclusion ranges for tobacco materials can vary depending on the nature and type of the tobacco material, and the intended effect on the final composition, with an example range of up to about 30% by weight (or up to about 20% by weight or up to about 10% by weight or up to about 5% by weight), based on total weight of the composition (e.g., about 0.1 to about 15% by weight). In some embodiments, the products of the disclosure can be characterized as completely free or substantially free of tobacco material (other than purified nicotine as an active ingredient). For example, certain embodiments can be characterized as having less than 1% by weight, or less than 0.5% by weight, or less than 0.1% by weight of tobacco material, or less than 0.01% by weight of tobacco material, or 0% by weight of tobacco material.

### Oral Care Additives

In some embodiments, the composition comprises an oral care ingredient (or mixture of such ingredients). Oral care ingredients provide the ability to inhibit tooth decay or loss, inhibit gum disease, relieve mouth pain, whiten teeth, or otherwise inhibit tooth staining, elicit salivary stimulation, inhibit breath malodor, freshen breath, or the like. For example, effective amounts of ingredients such as thyme oil, eucalyptus oil and zinc (e.g., such as the ingredients of formulations commercially available as ZYTEX® from Discus Dental) can be incorporated into the composition. Other examples of ingredients that can be incorporated in desired effective amounts within the present composition can include those that are incorporated within the types of oral care compositions set forth in Takahashi et al., Oral Microbiology and Immunology, 19(1), 61-64 (2004); U.S. Pat. No. 6,083,527 to Thistle; and US Pat. Appl. Pub. Nos. 2006/0210488 to Jakubowski and 2006/02228308 to Cummins et al. Other exemplary ingredients of tobacco containing-formulation include those contained in formulations marketed as MALTISORB® by Roquette and DENTIZYME® by NatraRx. When present, a representative amount of oral care additive is at least about 1%, often at least about 3%, and frequently at least about 5% of the total dry weight of the composition. The amount of oral care additive within the composition will not typically exceed about 30%, often will not exceed about 25%, and frequently will not exceed about 20%, of the total dry weight of the composition.

### Processing Aids

If necessary for downstream processing of ingredients of the product, such as granulation or mixing, or of the product itself, such as tableting, a processing aid (e.g., a flow aid) can also be included among the product ingredients in order to enhance e.g., flowability or compression of ingredients. Example processing aids include microcrystalline cellulose, silica, polyethylene glycol, stearic acid, calcium stearate, magnesium stearate, zinc stearate, sodium stearyl fumarate, canauba wax, and combinations thereof. In some embodiments, the processing aid is a flow aid or lubricant. In some embodiments, the flow aid or lubricant is silica, stearic acid, magnesium stearate, or a combination thereof.

When present, a representative amount of processing aid may make up at least about 0.5 percent or at least about 1 percent of the total weight of the product. Preferably, the amount of processing aid within the product will not exceed about 5 percent, and frequently will not exceed about 3 percent of the total weight of the product.

### Other Additives

Other additives can be included in the disclosed composition. For example, the composition can be processed, blended, formulated, combined, and/or mixed with other materials or ingredients. The additives can be artificial, or can be obtained or derived from herbal or biological sources. Examples of further types of additives include thickening or gelling agents (e.g., fish gelatin), emulsifiers, preservatives (e.g., potassium sorbate and the like), disintegration aids, zinc or magnesium salts selected to be relatively water soluble for compositions with greater water solubility (e.g., magnesium or zinc gluconate) or selected to be relatively water insoluble for compositions with reduced water solubility (e.g., magnesium or zinc oxide), or combinations thereof. See, for example, those representative components, combination of components, relative amounts of those components, and manners and methods for employing those components, set forth in U.S. Pat. No. 9,237,769 to Mua et al., U.S. Pat. No. 7,861,728 to Holton, Jr. et al., US Pat. App. Pub. No. 2010/0291245 to Gao et al., and US Pat. App. Pub. No. 2007/0062549 to Holton, Jr. et al., each of which is incorporated herein by reference. Typical inclusion ranges for such additional additives can vary depending on the nature and function of the additive and the intended effect on the final composition, with an example range of up to about 10% by weight, based on total weight of the composition (e.g., about 0.1 to about 5% by weight).

The aforementioned additives can be employed together (e.g., as additive formulations) or separately (e.g., individual additive components can be added at different stages involved in the preparation of the final composition). Furthermore, the aforementioned types of additives may be encapsulated as provided in the final product or composition. Exemplary encapsulated additives are described, for example, in WO2010/132444 to Atchley, which has been previously incorporated by reference herein.

### Particulate

In some embodiments, any one or more component of the composition, or the composition as a whole, can be described as a particulate material or as in particulate form. As used herein, the term “particulate” refers to a material in the form of a plurality of individual particles, some of which can be in the form of an agglomerate of multiple particles, wherein the particles have an average length to width ratio less than 2:1, such as less than 1.5:1, such as about 1:1. In various embodiments, the particles of a particulate material can be described as substantially spherical or granular.

The particle size of a particulate material may be measured by sieve analysis. As the skilled person will readily appreciate, sieve analysis (otherwise known as a gradation test) is a method used to measure the particle size distribution of a particulate material. Typically, sieve analysis involves a nested column of sieves which comprise screens, preferably in the form of wire mesh cloths. A pre-weighed sample may be introduced into the top or uppermost sieve in the column, which has the largest screen openings or mesh size (i.e. the largest pore diameter of the sieve). Each lower sieve in the column has progressively smaller screen openings or mesh sizes than the sieve above. Typically, at the base of the column of sieves is a receiver portion to collect any particles having a particle size smaller than the screen opening size or mesh size of the bottom or lowermost sieve in the column (which has the smallest screen opening or mesh size).

In some embodiments, the column of sieves may be placed on or in a mechanical agitator. The agitator causes the vibration of each of the sieves in the column. The mechanical agitator may be activated for a pre-determined period of time in order to ensure that all particles are collected in the correct sieve. In some embodiments, the column of sieves is agitated for a period of time from 0.5 minutes to 10 minutes, such as from 1 minute to 10 minutes, such as from 1 minute to 5 minutes, such as for approximately 3 minutes. Once the agitation of the sieves in the column is complete, the material collected on each sieve is weighed. The weight of each sample on each sieve may then be divided by the total weight in order to obtain a percentage of the mass retained on each sieve. As the skilled person will readily appreciate, the screen opening sizes or mesh sizes for each sieve in the column used for sieve analysis may be selected based on the granularity or known maximum/minimum particle sizes of the sample to be analysed. In some embodiments, a column of sieves may be used for sieve analysis, wherein the column comprises from 2 to 20 sieves, such as from 5 to 15 sieves. In some embodiments, a column of sieves may be used for sieve analysis, wherein the column comprises 10 sieves. In some embodiments, the largest screen opening or mesh sizes of the sieves used for sieve analysis may be 1000 μm, such as 500 μm, such as 400 μm, such as 300 μm.

In some embodiments, any material referenced herein (e.g., filler, tobacco material, and the overall oral product) characterized as being in particulate form may have at least 50% by weight of particles with a particle size as measured by sieve analysis of no greater than about 1000 μm, such as no greater than about 500 μm, such as no greater than about 400 μm, such as no greater than about 350 μm, such as no greater than about 300 μm. In some embodiments, at least 60% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm. In some embodiments, at least 70% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm. In some embodiments, at least 80% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm. In some embodiments, at least 90% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm. In some embodiments, at least 95% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm. In some embodiments, at least 99% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm. In some embodiments, approximately 100% by weight of the particles of any particulate material referenced herein have a particle size as measured by sieve analysis of no greater than about 1000 μm, such as no greater than about 500 μm, such as no greater than about 400 μm, such as no greater than about 350 μm, such as no greater than about 300 μm.

In some embodiments, at least 50% by weight, such as at least 60% by weight, such as at least 70% by weight, such as at least 80% by weight, such as at least 90% by weight, such as at least 95% by weight, such as at least 99% by weight of the particles of any particulate material referenced herein have a particle size as measured by sieve analysis of from about 0.01 μm to about 1000 μm, such as from about 0.05 μm to about 750 μm, such as from about 0.1 μm to about 500 μm, such as from about 0.25 μm to about 500 μm. In some embodiments, at least 50% by weight, such as at least 60% by weight, such as at least 70% by weight, such as at least 80% by weight, such as at least 90% by weight, such as at least 95% by weight, such as at least 99% by weight of the particles of any particulate material referenced herein have a particle size as measured by sieve analysis of from about 10 μm to about 400 μm, such as from about 50 μm to about 350 μm, such as from about 100 μm to about 350 μm, such as from about 200 μm to about 300 μm.

### Configured for Oral Use

Provided herein is a composition configured for oral use. The term “configured for oral use” as used herein means that the composition is provided in a form such that during use, saliva in the mouth of the user causes one or more of the components of the composition (e.g., flavoring agents and/or active ingredients) to pass into the mouth of the user. In certain embodiments, the composition is adapted to deliver components to a user through mucous membranes in the user's mouth, the user's digestive system, or both, and, in some instances, said component is an active ingredient (including, but not limited to, for example, a stimulant, vitamin, taste modifier, or combination thereof) that can be absorbed through the mucous membranes in the mouth or absorbed through the digestive tract when the product is used.

Compositions configured for oral use as described herein may take various forms, including gels, pastilles, gums, chews, melts, tablets, pellets, lozenges, beads, and powders, any of which may be contained within a pouch. Certain compositions of the disclosure are in the form of solids. Certain compositions can exhibit, for example, one or more of the following characteristics: crispy, granular, chewy, syrupy, pasty, fluffy, smooth, and/or creamy. In certain embodiments, the desired textural property can be selected from the group consisting of adhesiveness, cohesiveness, density, dryness, fracturability, graininess, gumminess, hardness, heaviness, moisture absorption, moisture release, mouthcoating, roughness, slipperiness, smoothness, viscosity, wetness, and combinations thereof.

The compositions as disclosed herein can be formed into a variety of shapes, including pills, tablets, spheres, strips, films, sheets, coins, cubes, beads, ovoids, obloids, cylinders, bean-shaped, sticks, or rods. Cross-sectional shapes of the composition can vary, and example cross-sectional shapes include circles, squares, ovals, rectangles, and the like. Such shapes can be formed in a variety of manners using equipment such as moving belts, nips, extruders, granulation devices, compaction devices, and the like.

In certain embodiments, the composition is in the form of a compressed or molded pellet or tablet. The pellet or tablet can have any of a variety of shapes, including traditional pill or tablet shapes. Example pellet or tablet weights range from about 25 mg to about 1500 mg, such as from about 25 mg to about 250 mg, from about 250 mg to about 500 mg, from about 500 to about 700 mg, or from about 700 mg to about 1500 mg.

The compositions of the present disclosure may be dissolvable. As used herein, the terms “dissolve,” “dissolving,” and “dissolvable” refer to compositions having aqueous-soluble components that interact with moisture in the oral cavity and enter into solution, thereby causing gradual consumption of the composition. In some embodiments, the dissolvable composition is capable of lasting in the user's mouth for a given period of time until it substantially completely or completely dissolves. Dissolution rates can vary over a wide range, from about 1 minute or less to about 60 minutes. For example, fast release compositions typically dissolve and/or release the desired component(s) (e.g., active ingredient, flavor, and the like) in about 2 minutes or less, often about 1 minute or less (e.g., about 50 seconds or less, about 40 seconds or less, about 30 seconds or less, or about 20 seconds or less). In some embodiments, the dissolution rate is more gradual, such as dissolving and/or releasing the desired component(s) (e.g., active ingredient, flavor, and the like) over a period of time of about 60 minutes or less, such as about 45 minutes, about 30 minutes, or about 15 minutes. Dissolution can occur by any means, such as melting, mechanical disruption (e.g., chewing), enzymatic or other chemical degradation, or by disruption of the interaction between the components of the composition.

Compositions configured for oral use as described herein comprise the composition of the present disclosure disposed within a moisture-permeable container (e.g., a water-permeable pouch). Such compositions in the water-permeable pouch format are typically used by placing one pouch containing the composition in the mouth of a human subject/user. Generally, the pouch is placed somewhere in the oral cavity of the user, for example under the lips, in the same way as moist snuff products are generally used. The pouch preferably is not chewed or swallowed. Exposure to saliva then causes some of the components of the composition therein (e.g., flavoring agents and/or active ingredients) to pass through e.g., the water-permeable pouch and provide the user with flavor and satisfaction, and the user is not required to spit out any portion of the composition. After about 10 minutes to about 60 minutes, typically about 15 minutes to about 45 minutes, of use/enjoyment, substantial amounts of the composition have been absorbed through oral mucosa of the human subject, and the pouch may be removed from the mouth of the human subject for disposal. Accordingly, in certain embodiments, the composition as disclosed herein is disposed within a moisture-permeable packet or pouch that acts as a container for use of the composition to provide a pouched product configured for oral use. In some embodiments, the pouch may be dissolvable as well.

In some embodiments, the composition is in particulate form (e.g., granular) enclosed within a pouch, and is substantially dissolved in less than about 10 minutes, such as from about 5 to about 10 minutes. In some embodiments, the composition is in a beaded form (e.g., roughly spherical beads) enclosed within a pouch, and is substantially dissolved in less than about 15 minutes, such as from about 10 to about 15 minutes. In some embodiments, the composition is in the form of one or more compressed or molded pellets (e.g., one or more tablets, also referred to herein as “agglomerates”) enclosed within a pouch, and is substantially dissolved in less than about 30 minutes, such as from about 20 to about 30 minutes. The dissolution rate may vary depending on such factors as the size, density, and surface area of the powder, granules, beads, pellets, or the like present within the pouch, as well as the quantity of composition by weight present within the pouch. Further, the dissolution rate may vary depending on the choice of filler and the solubility of other components present within the composition.

In some embodiments, the compressed or molded pellet within the pouch is subjected to a mechanical force prior to or when placed in the mouth of the user, such as breaking, crushing, or biting down on the pouched composition in order to increase the rate of dissolution of the composition and the individual components therein (e.g., flavorants, active ingredients, and the like).

### Preparation of the Composition

The compositions of the disclosure may generally be prepared, for example, by dry-blending dry ingredients, such as fillers, active ingredients, salts, buffers, flavoring agents, and the like, and combining the dry mixture with any liquid ingredients, such as water, binders, and the like, followed by placing the composition in a pouch.

The manner by which the various components of the composition are combined may vary. As such, the overall composition with e.g., powdered composition components may be relatively uniform in nature. The components noted above, which may be in liquid or dry solid form, can be admixed in a pretreatment step prior to mixture with any remaining components of the composition, or simply mixed together with all other liquid or dry ingredients. The various components of the composition may be contacted, combined, or mixed together using any mixing technique or equipment known in the art. Any mixing method that brings the composition ingredients into intimate contact can be used, such as a mixing apparatus featuring an impeller or other structure capable of agitation. Examples of mixing equipment include casing drums, conditioning cylinders or drums, liquid spray apparatus, conical-type blenders, ribbon blenders, mixers available as FKM130, FKM600, FKM1200, FKM2000 and FKM3000 from Littleford Day, Inc., Plough Share types of mixer cylinders, Hobart mixers, and the like. See also, for example, the types of methodologies set forth in U.S. Pat. No. 4,148,325 to Solomon et al.; U.S. Pat. No. 6,510,855 to Korte et al.; and U.S. Pat. No. 6,834,654 to Williams, each of which is incorporated herein by reference. In some embodiments, the components forming the composition are prepared such that the mixture thereof may be used in a starch molding process for forming the composition. Manners and methods for formulating compositions will be apparent to those skilled in the art. See, for example, the types of methodologies set forth in U.S. Pat. No. 4,148,325 to Solomon et al.; U.S. Pat. No. 6,510,855 to Korte et al.; and U.S. Pat. No. 6,834,654 to Williams, U.S. Pat. No. 4,725,440 to Ridgway et al., and U.S. Pat. No. 6,077,524 to Bolder et al., each of which is incorporated herein by reference.

In one embodiment is provided a method of preparing a composition as disclosed herein, the method comprising mixing a filler, at least one active ingredient, and a salt to form a dry blend. In some embodiments, the method further comprises adding one or more binders to the dry blend. In some embodiments, the method further comprises adding a buffer, one or more sweeteners, a humectant, a flavoring, or a combination thereof, to the dry blend. In some embodiments, the method further comprises adding water to the dry blend. In some embodiments, the composition (e.g., the dry blend) is then placed in a pouch to form a pouched product.

In some embodiments, the composition is loaded within the pouch using vacuum filling. The use of such vacuum filling techniques allows a higher loading density of the composition within the pouch volume by eliminating air pockets within the composition. Such high density loading may be desirable, for example, to provide a longer lasting product, or to provide more flavor and/or active ingredient to the consumer without increasing pouch size.

In some embodiments, the density of the composition is increased prior to enclosing in the pouch. Increasing the density of the composition may comprise decreasing an average particle size of the composition, increasing a moisture level of the composition, compressing the composition, or combinations thereof. Increasing the density of the composition allows higher loading of the composition within the available pouch volume. As noted herein above, such higher loading may be desirable, for example, to provide a longer lasting product, or to provide more flavor and/or active ingredient to the consumer without increasing pouch size.

In some embodiments, the composition is loaded within the pouch at a density which is generally greater than about 0.45 g/cm³, such as from about 0.45 to about 2 g/cm³, or from about 0.5 g/cm³ to about 1.5 g/cm³. In some embodiments, the composition is loaded within the pouch at a density from about 0.45, about 0.5, about 0.55, about 0.6, about 0.65, about 0.7, about 0.75, about 0.8, about 0.85, about 0.9, about 0.95, or about 1 g/cm³, to about 1.1, about 1.2, about 1.3, about 1.4, about 1.5, about 1.6, about 1.7, about 1.8, about 1.9, or about 2.0 g/cm³.

As used herein, the term “density” refers to apparent density or bulk density, defined as the mass of a particulate material divided by the total volume occupied by the material, including pores and water (apparent volume). The total volume includes particle volume, inter-particle void volume, and internal pore volume. Apparent or bulk density is not an intrinsic property of a material, and may change based on e.g., compaction of the material. Apparent volume can be measured by volumetric displacement in an immersion liquid, the buoyant force method, in which a sample is weighed inside and outside of an immersion liquid of known density, caliper measurement of dimensions and corresponding volume calculation, or by gas (e.g., helium) pycnometry. Unless otherwise indicated, reference to the density of a composition within the present disclosure is the bulk density determined by volumetric displacement or caliper measurement. The density may refer to the density of the composition itself, the density of loading of the composition within the volume of the pouch enclosing it, or both.

In some embodiments, the composition (e.g., the dry blend) is compressed to the desired density prior to enclosing in a pouch. Accordingly, in some embodiments, the method further comprises compressing the composition (e.g., the dry blend). For example, the composition may be compressed using conventional tableting techniques. Compressed pellets or tablets can be produced by compacting the dry blend in granular form, including any associated formulation components, in the form of a lozenge, pellet, tablet, or the like. Example compaction devices, such as compaction presses, are available as Colton 2216 and Colton 2247 from Vector Corporation and as 1200i, 2200i, 3200, 2090, 3090 and 4090 from Fette Compacting. Devices for providing outer coating layers to compacted pelletized products are available as CompuLab 24, CompuLab 36, Accela-Cota 48 and Accela-Cota 60 from Thomas Engineering.

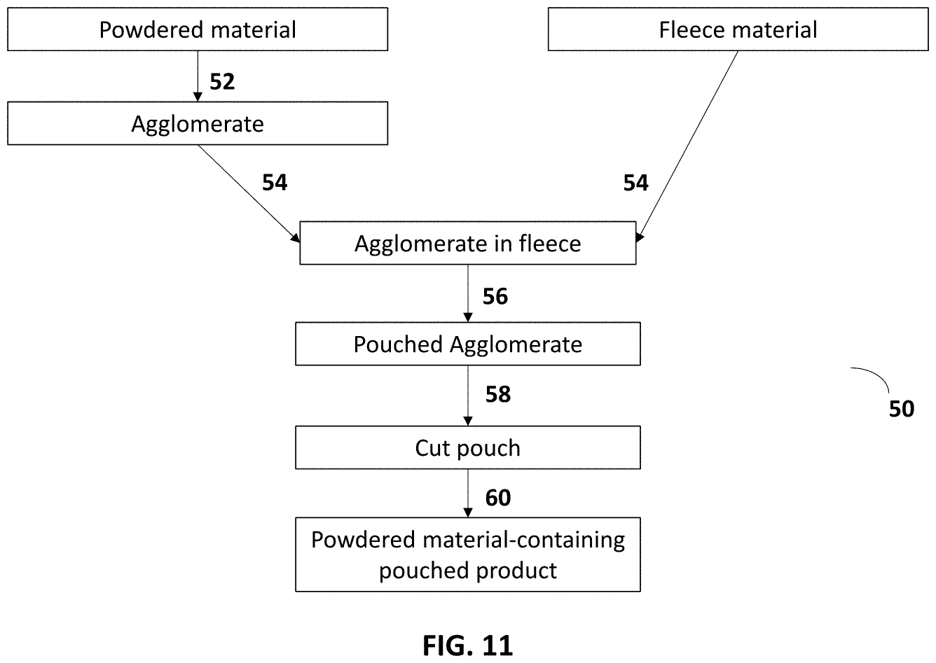

References herein to compressed pellets, tablets, and the like are also intended to cover “agglomerated material” and “agglomerates.” By “agglomerate” or “agglomerated material” or “agglomeration” is meant any compressed form of the powdered/granular composition. Although not limited thereto, an agglomeration is usually in a form such that a single agglomerate is included within a pouched product. The shape, size, and hardness of the agglomerate may vary across a wide range. Typically, an agglomerate is sufficiently compressed so as to be a cohesive form, e.g., to maintain its form throughout production of a pouched product containing the agglomerate. In certain embodiments, the agglomerate can be considered to be somewhat “loosely” compressed (so as to later be expanded by the optional addition of moisture, as will be described in further detail below with respect to the method shown in FIG. 11).

In some embodiments, following compression, the composition is in a compressed shape of predetermined form. Cross-sectional shapes of the composition can vary, and example cross-sectional shapes include circles, squares, ovals, rectangles, and the like. In certain embodiments, the composition is in the form of a compressed or molded pellet (or “agglomerate”), wherein the pellet can have any of a variety of shapes, including traditional pill or tablet shapes. The precise shape and size will depend on the desired application.

In some embodiments, the compressed shape, e.g., agglomerate, can be in a shape comparable to that of the final pouched product in which it is to be included. In some embodiments, the agglomerate can be circular/round or oblong in shape. The agglomerate can be flat or convex. The shape and size of the agglomerate can be controlled, e.g., by selecting an appropriately shaped/sized die for use in a tablet press or by selecting an appropriately shaped/sized mold. The size of the agglomerate is typically determined, at least in part, based on the amount of powdered material to be included within a given powdered product (i.e., an amount suitable for an individual pouched product) and the size of the pouched product in which it is to be included (e.g., to ensure fit within the pouched product). In some embodiments, the agglomerate is sized so as to substantially fill the cavity of the pouched product into which it is incorporated. The weight of the agglomerate is generally that weight of powdered material suitable for an individual pouched product.

The density of the composition following compression may vary, but generally allows a higher density of loading of the composition within a pouch than would be possible in the absence of such compression. In other words, the compression allows a small pouch volume to contain a larger quantity of composition than would be possible in the absence of compression. As referenced above, an agglomerate generally has a density such that it is generally able to withstand being ejected from a tablet press or mold and/or to maintain its shape when placed within a pouch material and/or sealed within a pouch material, but can, in some embodiments, be considered “loosely” compacted.

In some embodiments, prior to compressing, the dry blend is granulated, forming a plurality of granules. Granulation is the process in which particles of the individual components, in e.g., powder form, are made to adhere to form large, homogenous, multi-particle entities called granules. Granulation is particularly suitable in embodiments where the product includes a milled non-tobacco botanical material, a botanical extract, or certain flavorants. Milled botanical materials and extracts, as well as certain flavorants, by virtue of their high moisture and/or oil content, have a tendency to stick together, forming clumps which may result in a non-homogenous product in the absence of granulation. Such clumping is also undesirable during processing, as clumping may lead to difficulty in achieving adequate flow, and is particularly undesirable in compressed (e.g., tableted) embodiments. Any suitable means for granulation may be employed. For example, granulation can be conducted in a granulator under high-shear, low-shear, fluid bed, rotor, or melt granulation.

The dry blend may be mixed with a liquid binder or binder solution (e.g., by spraying a binder solution into the granulator) and granulated to a desired particle size, such as about 100 to about 200 microns. The dry blend is generally granulated with a binder solution to form a plurality of granules. As would be understood in the art, the binder solution facilitates agglomeration of the dry powder granulation mixture into larger granules. The binder solution used in the granulation process can be any aqueous or alcohol-based solution containing an appropriate binder or combination of binders. In some embodiments, the binder comprises a cellulose ether as described herein above. In some embodiments, the binder comprises polyvinylpyrrolidone, or a combination of a cellulose ether and polyvinylpyrrolidone. In some embodiments, the binder is polyvinylpyrrolidone. The molecular weight of the polyvinylpyrrolidone may vary, and is generally specified by reference to the letter “K” followed by a number. For example, in some embodiments, the polyvinylpyrrolidone is K29/32 or K30, meaning the polyvinylpyrrolidone has a mean molecular weight from 29,000 to 32,000, or 30,000, respectively.

The binder solution will typically have a solids content of about 3 to about 20 percent (w/w), and suitable solvents include water and ethanol. The binder solution used in the granulation process can be aqueous in nature. In some embodiments, the binder solution includes at least one active ingredient, at least one flavorant, or a combination thereof. The binder solution, the dry blend, or both, can contain other additives, including any of the additives discussed herein, such as salts, buffers, non-tobacco botanical material, sweeteners, processing aids, and the like. Such additives may be added before or after granulation.

The composition in the form of a compressed pellet or tablet can include an optional outer coating, which can help to improve storage stability of the composition as well as improve the packaging process by reducing friability and dusting. Accordingly, in some embodiments, the method further comprises coating the compressed composition in the predetermined shape. The coating typically comprises a film-forming polymer, such as a cellulosic material, an optional plasticizer, and optional flavorants, colorants, salts, sweeteners or other additives of the types set forth herein. The coating compositions are usually aqueous in nature and can be applied using any pellet or tablet coating technique known in the art, such as pan coating. Example film-forming polymers include cellulosic materials such as methylcellulose, hydroxypropyl cellulose (HPC), hydroxypropyl methylcellulose (HPMC), hydroxyethyl cellulose, and carboxymethylcellulose (CMC). Example plasticizers include aqueous solutions or emulsions of glyceryl monostearate and triethyl citrate. Additional potential coatings include food grade shellac, waxes such as carnuaba wax, and combinations thereof.

In one embodiment, the coating composition comprises up to about 75 weight percent of a film-forming polymer solution (e.g., about 40 to about 70 weight percent based on total weight of the coating formulation), up to about 5 weight percent of a plasticizer (e.g., about 0.5 to about 2 weight percent), up to about 5 weight percent of a sweetener (e.g., about 0.5 to about 2 weight percent), up to about 10 weight percent of one or more colorants (e.g., about 1 to about 5 weight percent), up to about 5 weight percent of one or more flavorants (e.g., about 0.5 to about 3 weight percent), up to about 2 weight percent of a salt such as NaCl (e.g., about 0.1 to about 1 weight percent), and the balance water. In some embodiments, the coating comprises at least one flavorant.

Following the optional coating, the product can be dried to a final desired moisture level. The moisture content of the product prior to use by a consumer can vary. Typically, the moisture content of the product, as present within a single unit of product prior to insertion into the mouth of the user, is within the range of about 2 to about 6 weight percent (e.g., about 4 percent) based on the total weight of the product unit. Control of the final moisture of the product can be important for storage stability.

The manner by which the moisture content of the product is controlled may vary. For example, the product can be subjected to thermal or convection heating. As a specific example, the product may be oven-dried, in warmed air at temperatures of about 40° C. to about 95° C., with a preferred temperature range of about 60° C. to about 80° C., for a length of time appropriate to attain the desired moisture content.

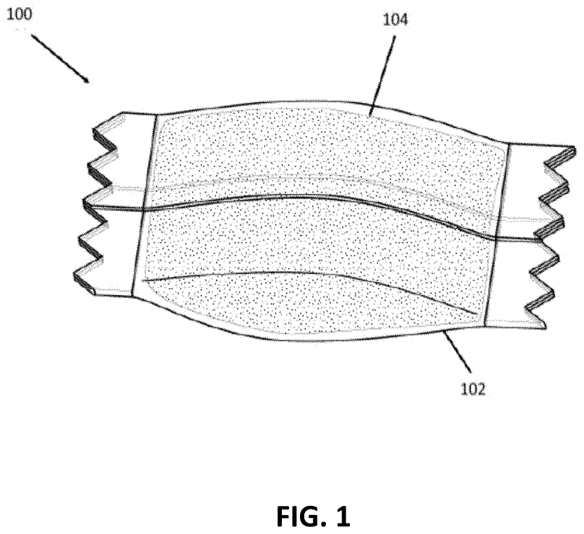

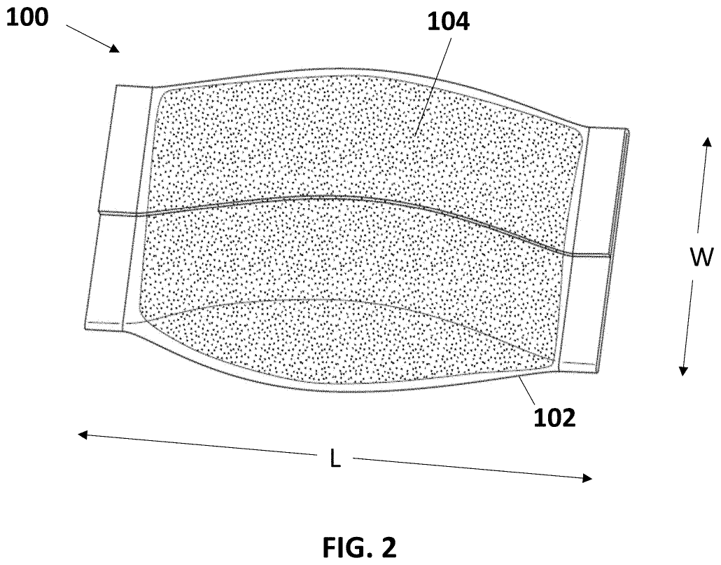

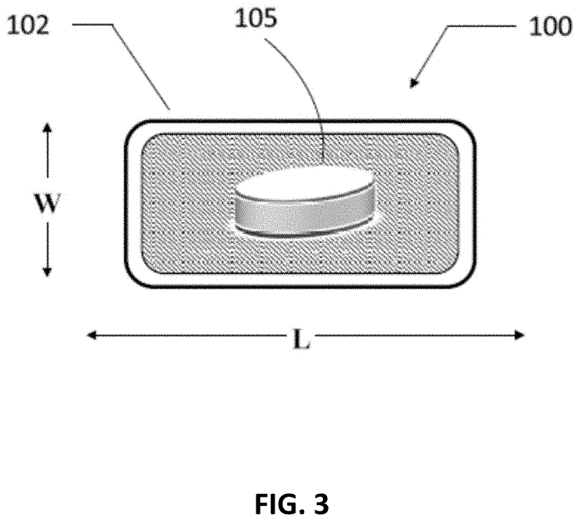

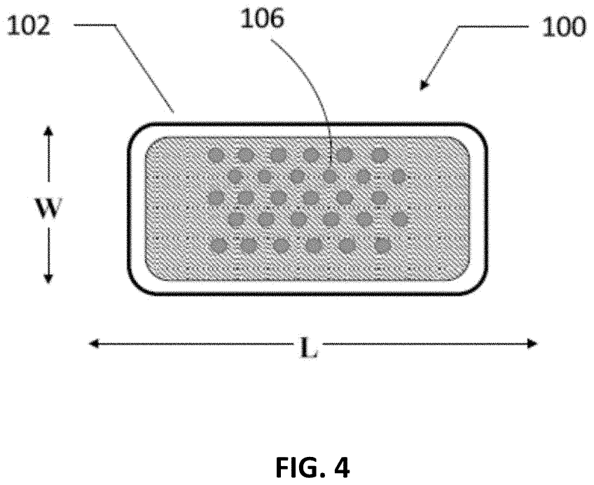

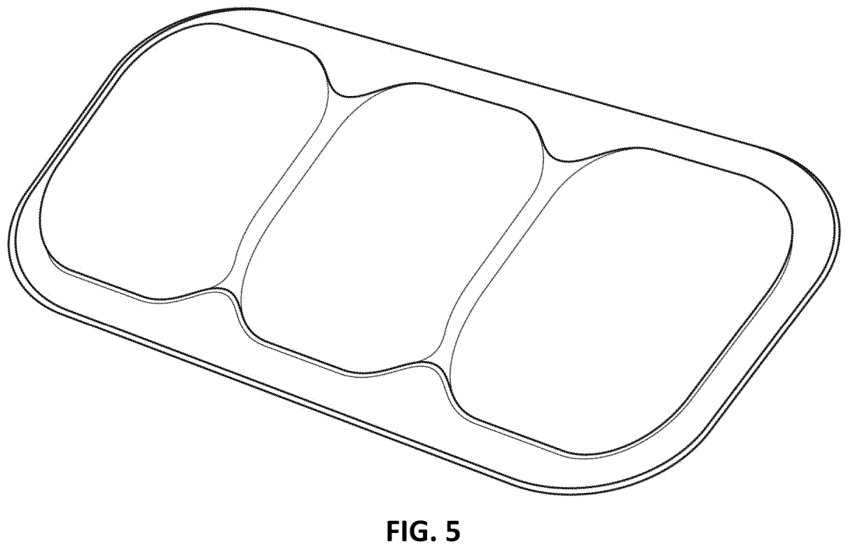

The composition in compressed (e.g., tablet, pellet, or agglomerate form) is then placed within a pouch. Certain embodiments of the disclosure will be described with reference to FIGS. 1-10 of the accompanying drawings, and these described embodiments involve snus-type products having an outer pouch and containing the composition as described herein. As explained in greater detail below, such embodiments are provided by way of example only. The composition/construction of such packets or pouches, such as the container pouch 102 in the embodiments illustrated in FIGS. 1-4 (and present within FIGS. 5-10, but not explicitly indicated as such), may be varied. Referring to FIGS. 1 and 2, there are shown embodiments of pouched products 100. The pouched products 100 each include a moisture-permeable container in the form of a pouch 102, which contains a material 104 comprising the composition as described herein (which can, in some embodiments, comprise or be in the form of an agglomerate as described above) Referring to FIG. 3, there is shown an embodiment of a pouched product 100 including a moisture-permeable container in the form of a pouch 102, which contains the composition as described herein in tablet form 105. Referring to FIG. 4, there is shown an embodiment of a pouched product 100 including a moisture-permeable container in the form of a pouch 102, which contains the composition as described herein as multiple compressed pellets, tablets, or beads 106.

In some embodiments, the overall size, dimensions, and shape of a pouched product and the packing density of the composition within the water-permeable pouch can affect dissolution of the composition contained therein. In some embodiments, both the overall size and shape of the pouched product and the packing density of the composition within the water-permeable pouch can affect release of soluble component(s) (e.g., active agents and/or flavorants) from the pouched product into a user's oral cavity. Accordingly, by modulating these features of a pouched product, pouched products can be tailored to exhibit an array of release profiles as desired. Furthermore, it has been found that both the overall size and shape of a pouched product and the packing density of the composition within the water-permeable pouch can affect the mouthfeel of the pouched product within a user's oral cavity and, correspondingly can impact a user's perception of the pouched product. As such, in some embodiments, by tailoring the size and/or shape of pouched products, the products may, in some embodiments, more readily be accommodated within a user's oral cavity. In other words, shaped pouches can be suitably designed to conform to a portion of the shape of the oral cavity of a user. For example, in some embodiments, shaped pouches are provided, at least a part of which more closely resembles the curve of a user's jaw and/or gumline, so as to increase the comfort within the oral cavity during use. In some embodiments, the disclosed shaped pouched products are described as being more comfortably accommodated or retained within the oral cavity during use than conventional pouched products

According to certain embodiments, pouched products are provided with alternative shapes and/or sizes relative to conventional pouched products. The exact shapes and sizes of pouches provided herein are not particularly limited. Various shapes can be described, for example, as “circular,” “oval,” “oblong,” “crescent-shaped,” “rounded crescent-shaped,” “half-moon-shaped,” “half-circular,” “teardrop-like,” “star-shaped,” “domed,” “rhombic,” “rounded rhombic,” “diamond-shaped,” “rounded diamond-shaped,” “kidney-shaped,” “heart-shaped,” “triangular,” “rounded triangular” (including, e.g., isosceles, equilateral, scalene, acute, right, and obtuse) “hexagonal,” “rounded hexagonal” (including hexagonal with equal length edges and with varying length edges) and the like. The term “rounded” in such definitions refers to rounded edges (rather than the sharp edges). The provided shapes may be substantially uniform in thickness or may vary across the length or width of the pouched product, e.g., providing a three-dimensionally shaped structure such as a dome (with a higher center), or a cone-typed structure (e.g., with greater thickness at the bottom of a triangular or rounded triangular-type shape).

Certain, non-limiting depictions of pouched products having alternative shapes and/or sizes are depicted in FIGS. 5-10 and will be described in further detail herein below. Such pouched product shapes are further described in U.S. Design patent application No. 29/801,788, filed Jul. 30, 2021 and U.S. patent application Ser. No. 17/971,954, which are both incorporated herein by reference in their entireties.

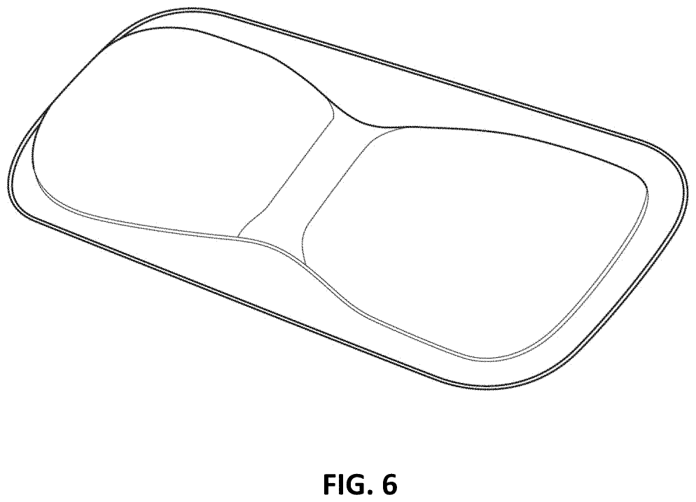

FIGS. 5 and 6 provide pouched product shapes comprising “compartments” formed by the water-permeable pouch material, wherein one or more (e.g., all) such compartments contain the composition therein. The number of compartments can vary and can be, e.g., at least two (including two compartments, as shown in FIG. 5), at least three (including three compartments, as shown in FIG. 6), or least four (including four compartments), and further on. Typically, although not limited thereto, the composition, where contained in multiple compartments, is the same composition—but could differ as long as the composition is of similar properties that would allow for comparable release in the same manner. Such compartments can be substantially the same size as one another or can vary in size. In the depicted embodiment, all three compartments are substantially the same size. Typically, all filled compartments are filled with the same fill density (e.g., including embodiments where all compartments are equally filled, providing for an even distribution of the composition in the pouched product overall). Some such embodiments can include complete or partial seals between adjacent compartments, e.g., such that composition cannot readily pass from one compartment to an adjacent compartment.

In some such embodiments, a pouched product shape such as depicted in FIGS. 5 and 6 exhibits “bulging” of the compartments, which can be associated with a distinct mouthfeel/user perception. In some embodiments, one or more ridges/grooves of such embodiments formed between adjacent compartments in the pouched products can be advantageous in modulating mouthfeel/user perception. Such grooves may be uniform (as shown) or non-uniform (e.g., with different distances between different adjacent grooves). In some embodiments, such shapes are considered to provide good curvature fit within certain users' oral cavities. The outer edges of these pouched product shapes can vary and can be smooth (as shown), serrated, sharp (e.g., with four 90 degree angles at the four corners), etc. In some embodiments, a smooth outer edge is desirable, with no sharp edges. In some embodiments, a pouched product shape such as depicted in FIG. 5 exhibits a quick release of certain components (e.g., active ingredients); in some embodiments, this pouched product shape can also exhibit a long-lasting release/dissolution profile with respect to flavorants contained therein, e.g., over a course of 15 minutes or more. In some embodiments, a pouched product shape such as depicted in FIG. 6 exhibits a quick release of certain components (e.g., active ingredients).

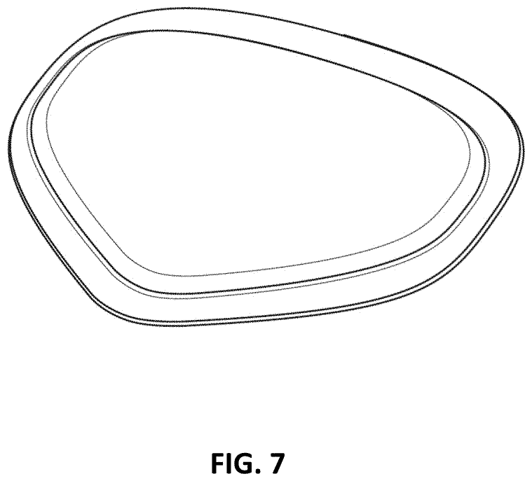

FIG. 7 provides a pouched product shape comprising five sides (e.g., a pentagon-type shape with rounded edges). The lengths of the sides of the pouched product can vary; in some embodiments, as depicted, one side is longer and the other four sides are substantially similar in length. According to certain embodiments of the present disclosure, the composition can be packed/filled within the pouched product in varying ways. Again, while conventional pouched products typically contain a composition (e.g., a particulate composition) contained within a water permeable pouch, where the composition is loosely contained therein, some embodiments according to the present disclosure, provide a pouched product such as depicted in FIG. 7 with high packing density. In some embodiments, the packing of the composition within the outer permeable pouch is considered to provide a largely “flat” design, such that it provides a good fit within the oral cavity of a user. The outer edges of these pouched product shapes can vary and can be smooth (as shown), serrated, sharp, etc. In some embodiments, a smooth outer edge is desirable, with no sharp edges. In some such embodiments, a pouched product shape such as depicted in FIG. 7 can be considered to provide for comfortable placement within a user's oral cavity and/or less pressure on the gums during use than a conventionally shaped pouched product. In some such embodiments, a pouched product shape such as depicted in FIG. 7 exhibits a somewhat constant release of components (e.g., active ingredients and/or flavorant), e.g., providing an active ingredient concentration in the oral cavity with a somewhat delayed release and/or gradual buildup and consistent release. In some embodiments, the release of active ingredient and/or flavorant can be considered to be somewhat consistent/with a long-lasting release/dissolution profile, e.g., over a course of 15 minutes or more.

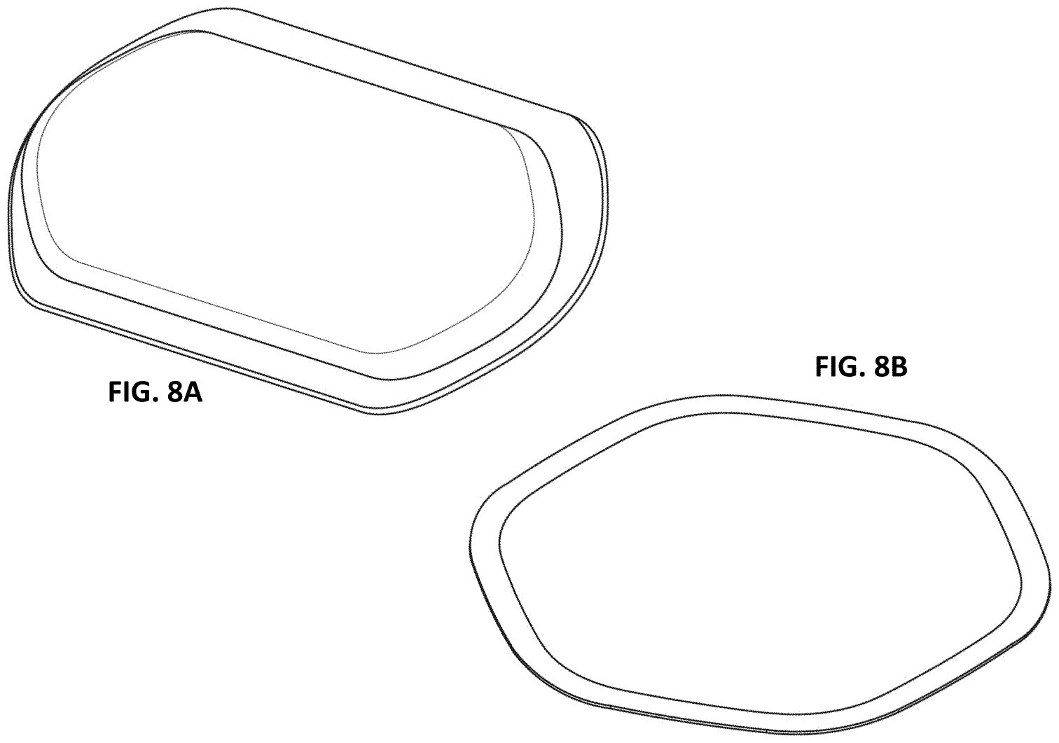

FIGS. 8A and 8B provide pouched product shapes comprising six sides (e.g., a hexagon-type shape with rounded edges). The lengths of the sides of the pouched product can vary; in some embodiments, as depicted in FIG. 8A, two, opposite sides are longer and the other four sides are substantially similar in length. In other embodiments, as depicted in FIG. 8B, all sides are substantially the same length. According to certain embodiments of the present disclosure, the composition can be packed/filled within the pouched product in varying ways. Again, while conventional pouched products typically contain a composition (e.g., a particulate composition) contained within a water permeable pouch, where the composition is loosely contained therein, some embodiments according to the present disclosure, provide pouched products such as depicted in FIGS. 8A and 8B with high packing density. In some embodiments, the packing of the composition within the outer permeable pouch is considered to provide a largely “flat” design, such that it provides a good fit within the oral cavity of a user. The outer edges of these pouched product shapes can vary and can be smooth (as shown), serrated, sharp, etc. In some embodiments, a smooth outer edge is desirable, with no sharp edges. However, the seemingly pointed edges of the hexagon shape can, in some embodiments, significantly affect a user's perception of the pouched product. In some embodiments, pouched product shapes such as depicted in FIGS. 8A and 8B can exhibit a high sensation instancy and amplitude.

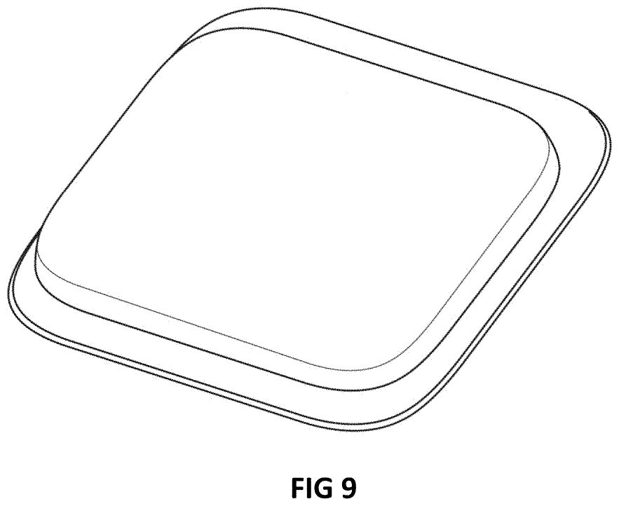

FIG. 9 provides a pouched product shape comprising four sides (e.g., a square or rectangular-type shape with rounded edges and roughly 90-degree angles between adjacent sides). The lengths of the sides of the pouched product can vary; in some embodiments, as depicted, two, opposite sides are longer and the other two sides are shorter in length. According to certain embodiments of the present disclosure, the composition can be packed/filled within the pouched product in varying ways. Again, while conventional pouched products typically contain a composition (e.g., a particulate composition) contained within a water permeable pouch, where the composition is loosely contained therein, some embodiments according to the present disclosure, provide a pouched product such as depicted in FIG. 9 with high packing density. In some embodiments, the packing of the composition within the outer permeable pouch is considered to provide a largely “flat” design, such that it provides a good fit within the oral cavity of a user. The outer edges of these pouched product shapes can vary and can be smooth (as shown), serrated, sharp, etc. In some embodiments, a smooth outer edge is desirable, with no sharp edges. In some such embodiments, a pouched product shape such as depicted in FIG. 9 can be considered to provide for comfortable placement within a user's oral cavity and/or less pressure on the gums during use than a conventionally shaped pouched product. In some embodiments, this design is considered to have a convenient fit with low bulge.

In some such embodiments, a pouched product shape such as depicted in FIG. 9 can exhibit a fast, sharp sensation onset and amplitude. In some embodiments, the flavor intensity is relatively short lived.

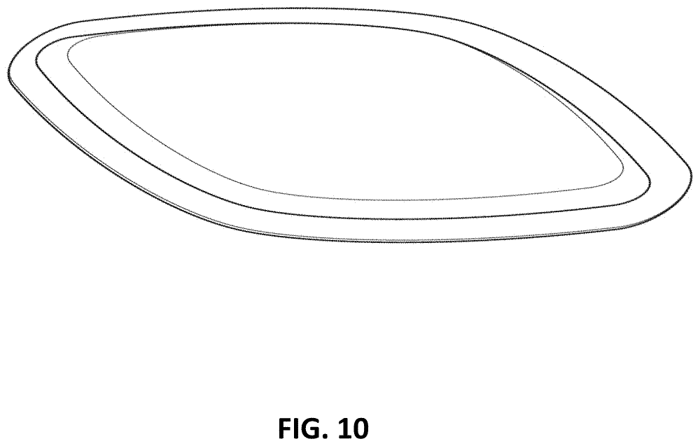

FIG. 10 provides another pouched product shape comprising four sides, but in the form of a parallelogram (e.g., with two pairs of opposite parallel sides and with non-90 degree angles between adjacent sides). The lengths of the sides of the pouched product can vary; in some embodiments, two, opposite sides are longer and the other two sides are substantially similar in length. In other embodiments (as depicted), all sides are roughly the same length. According to certain embodiments of the present disclosure, the composition can be packed/filled within the pouched product in varying ways. Again, while conventional pouched products typically contain a composition (e.g., a particulate composition) contained within a water permeable pouch, where the composition is loosely contained therein, some embodiments according to the present disclosure, provide a pouched product such as depicted in FIG. 10 with high packing density. In some embodiments, the packing of the composition within the outer permeable pouch is considered to provide a largely “flat” design, such that it provides a good fit within the oral cavity of a user. The outer edges of these pouched product shapes can vary and can be smooth (as shown), serrated, sharp, etc. In some embodiments, a smooth outer edge is desirable, with no sharp edges. In some such embodiments, a pouched product shape such as depicted in FIG. 10 can be considered to allow for an easy fit under the gums with snug placement there during use.

In some such embodiments, a pouched product shape such as depicted in FIG. 10 can exhibit a somewhat quick but controlled sensation within the oral cavity.

The disclosed pouched products can be provided in a range of sizes; it is to be understood that dissolution of the mixture contained therein will change based on size. In some embodiments, the pouched products provided herein are designed so as to be substantially similar in size to conventional pouched products. In other embodiments, they may be somewhat larger in size or somewhat smaller in size than typical/conventional pouched products. In some embodiments, a largest dimension (length, e.g., shown in the examples of FIGS. 1-4 as “L”) is about 16 to about 40 mm or about 20 to about 40 mm, e.g., about 16 mm, about 17 mm, about 18 mm, about 19 mm, about 20 mm, about 21 mm, about 22 mm, about 23 mm, about 24 mm, about 25 mm, about 26 mm, about 27 mm, about 28 mm, about 29 mm, 30 mm, about 31 mm, about 32 mm, about 33 mm, about 34 mm, about 35 mm, about 36 mm, about 37 mm, about 38 mm, about 39 mm, or about 40 mm. In some embodiments, the largest perpendicular dimension to the length (width, shown in the examples of FIGS. 1-4 as “W”) is about 8 to about 20 mm or about 10 to about 20 mm, e.g., about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm. Certain non-limiting embodiments have rough largest dimensions of about 38 mm (length)×about 18 mm (width); about 37.5 mm (length)×about 12 mm (width); about 38 mm (length)×about 12 mm (length); about 33 mm (length)×about 18 mm (width); about 33 mm (length)×about 12 mm (length), about 31 mm (length)×about 12 mm (width), about 30 mm (length)×about 12 mm (width), about 29 mm (length)×about 14 mm (width), about 28 mm (length)×about 13 mm (width), about 28 mm (length)×about 12 mm (width), about 27 mm (length)×about 16 mm (width), about 24 mm (length)×about 12 mm (width) and about 22 mm (length)×about 13 mm (width).

The third dimension (thickness, T, not shown in FIGS. 1-4), understood to represent the 3-dimensional thickness of the products, can vary based, e.g., upon the packing of the composition as described herein). In some embodiments, the thickness can vary, e.g., from about 1 mm to about 20 mm or about 2 mm to about 10 mm, although the disclosure is not limited thereto. Certain examples of thicknesses include, e.g., about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm at the pouch's thickest point.

In some embodiments, the dimensions of the disclosed pouches can be similar to those of conventional pouched products.

In some embodiments, the disclosed pouches are smaller in size than conventional pouched products, e.g., such that the total length, width, and thickness of the pouched product is about 130 mm or less, about 120 mm or less, about 110 mm or less, about 100 mm or less, about 90 mm or less, about 80 mm or less, about 70 mm or less, about 60 mm or less, about 50 mm or less, or about 40 mm or less, e.g., about 30 mm to about 130 mm, about 30 mm to about 100 mm, about 50 to about 100 mm, or about 50 to about 70 mm. Advantageously, in such embodiments, the thickness of such pouched products is about 8 mm or less. Surface area of certain pouches (defined as length times width×2) is about 900 mm² or less, about 800 mm² or less, about 700 mm² or less, about 600 mm² or less, about 500 mm² or less, about 400 mm² or less, about 300 mm² or less, about 250 mm² or less, about 200 mm² or less, or about 150 mm² or less (e.g., with a minimum of about 100 mm² in some embodiments). In some embodiments, these smaller pouches can provide for faster release of the flavorant and/or active ingredient from the internal material to the consumer's oral cavity during use as compared with larger pouches (e.g., conventional pouches that are of analogous composition, but with larger dimensions). In certain embodiments, such pouches can provide for more comfort within the consumer's oral cavity, given their smaller size as compared with conventional pouched products. Such size can allow these products to be, in some embodiments, more readily accommodated at various positions within the oral cavity. Such smaller products also may, in some embodiments, allow for use to be more discrete (as the user may, in some embodiments, readily “hide” the product, e.g., between his/her gum and lip).

In some embodiments, the disclosed pouches can be considered larger in size than many conventional pouched products. For example, certain large pouches have a length L of about 35 to about 60 mm and a width W of about 8 to about 18 mm. Certain, non-limiting examples of large pouches provided herein are as follows: a large pouch with L≥35 mm and W≥8 mm, a large pouch with L≥35 mm and W≥10 mm, a large pouch with L≥35 mm and W≥12 mm, a large pouch with L≥35 mm and W≥14 mm, a large pouch with L≥35 mm and W≥16 mm, a large pouch with L≥40 mm and W≥8 mm, a large pouch with L≥40 mm and W≥10 mm, a large pouch with L≥40 mm and W≥12 mm, a large pouch with L≥40 mm and W≥14 mm, a large pouch with L≥40 mm and W≥16 mm, a large pouch with L≥50 mm and W≥8 mm, a large pouch with L≥50 mm and W≥10 mm, a large pouch with L≥50 mm and W≥12 mm, a large pouch with L≥50 mm and W≥14 mm, and a large pouch with L≥50 mm and W≥16 mm. Certain advantageous ranges of length and width of such large pouches are, in some embodiments, a length L of about 35 mm to about 60 mm, such as about 40 mm to about 60 mm, about 50 mm to about 60 mm, about 35 mm to about 50 mm, and about 35 mm to about 40 mm, and a width W of about 8 mm to about 16 mm, such as about 8 mm to about 14 mm, about 8 mm to about 12 mm, about 8 mm to about 10 mm, about 9 mm to about 16 mm, about 9 mm to about 14 mm, about 9 mm to about 12 mm, about 9 mm to about 10 mm, about 10 mm to about 16 mm, about 10 mm to about 14 mm, about 10 mm to about 12 mm, or about 14 to about 16. In various embodiments, the total measurements for the length, width, and thickness (i.e., adding all four sides of the pouch, plus the thickness) are within the following ranges. In some embodiments, the total length, width, and thickness of a large pouch as provided herein is about 90 mm or greater, about 100 mm or greater, about 110 mm or greater, about 120 mm or greater, about 130 mm or greater, about 140 mm or greater, or about 150 mm or greater. Advantageously, in such embodiments, the thickness of such pouches is about 2 mm or greater (e.g., between about 2 and about 8 mm). Surface area of certain large pouches (defined as length times width×2) is about 300 mm² or greater, about 400 mm² or greater, about 500 mm² or greater, about 600 mm² or greater, or about 700 mm² or greater (e.g., with a maximum of about 1000 mm²), although the disclosure is not limited thereto. In some embodiments, such large pouches can provide for slower release of the flavorant and/or active ingredient from the composition within the pouch to the consumer's oral cavity during use as compared with smaller pouches (e.g., conventional pouches that are of analogous composition, but with smaller dimensions). In certain embodiments, such large pouches can provide for greater user enjoyment, e.g., where the user has a larger oral cavity or prefers using multiple conventional pouches simultaneously, given their larger size as compared with conventional pouched products. In some embodiments, a larger pouch will allow for the inclusion of more material within the pouch. Such additional material may comprise any of the types of components described herein; in some embodiments, the inclu-sion of more material can involve the inclusion of greater amounts of active ingredient and/or greater amounts of flavorant than in conventional pouched products

Overall, certain design criteria are provided herein which may provide, in some embodiments, particularly advantageous pouch shapes, regardless of size. In some embodiments, as referenced herein, the disclosure provides pouched products of shapes other than conventional rectangles and squares (as referenced herein above with respect to “conventional” pouched products). Such products are provided in varying shapes and sizes. Advantageously, by tailoring the shape of pouched products, the products may, in some embodiments, more readily be accommodated within a user's oral cavity. In other words, shaped pouches can be suitably designed to conform to a portion of the shape of the oral cavity of a user. For example, in some embodiments, shaped pouches are provided which more closely resemble the curve of a user's jaw and/or gumline, so as to increase the comfort within the oral cavity during use. In some embodiments, the disclosed shaped pouched products are described as being more comfortably accommodated or retained within the oral cavity during use than conventional pouched products

For example, in some embodiments, pouch shapes are provided which have no sharp edges, i.e., exhibiting rounded edges. In some embodiments, pouch shapes are provided which are easy to move around within the mouth. In some embodiments, pouch shapes are provided which provide for easy mouth fit. In some embodiments, pouch shapes are provided which cover a reasonable area within the oral cavity (e.g., greater than conventional pouches). In some embodiments, pouch shapes are provided which cover a relatively small area within the oral cavity (e.g., less than conventional pouches), e.g., so as to fit easily under the gums (“compact” size). In some embodiments, pouch shapes are provided which allow for little to no pressure on the gums during use. In some embodiments, pouch shapes are provided which are designed to allow for comfort within the oral cavity, e.g., adapted to the shape of the oral cavity. In some embodiments, pouch shapes are provided which include one or more grooves. Suitable packets, pouches or containers of the type used for the manufacture of smokeless tobacco products are available under the tradenames CatchDry, Ettan, General, Granit, Goteborgs Rape, Grovsnus White, Metropol Kaktus, Mocca Anis, Mocca Mint, Mocca Wintergreen, Kicks, Probe, Prince, Skruf and TreAnkrare. The composition may be contained in pouches and packaged, in a manner and using the types of components used for the manufacture of conventional snus types of products. The pouch provides a liquid-permeable container of a type that may be considered to be similar in character to the mesh-like type of material that is used for the construction of a tea bag. Components of the composition readily diffuse through the pouch and into the mouth of the user.

Non-limiting examples of suitable types of pouches are set forth in, for example, U.S. Pat. No. 5,167,244 to Kjerstad and U.S. Pat. No. 8,931,493 to Sebastian et al.; as well as US Patent App. Pub. Nos. 2016/0000140 to Sebastian et al.; 2016/0073689 to Sebastian et al.; 2016/0157515 to Chapman et al.; and 2016/0192703 to Sebastian et al., each of which is incorporated herein by reference. Pouches can be provided as individual pouches, or a plurality of pouches (e.g., 2, 4, 5, 10, 12, 15, 20, 25 or 30 pouches) can be connected or linked together (e.g., in an end-to-end manner) such that a single pouch or individual portion can be readily removed for use from a one-piece strand or matrix of pouches.

An example pouch may be manufactured from materials, and in such a manner, such that during use by the user, the pouch undergoes a controlled dispersion or dissolution. Such pouch materials may have the form of a mesh, screen, perforated paper, permeable fabric, or the like. For example, pouch material manufactured from a mesh-like form of rice paper, or perforated rice paper, may dissolve in the mouth of the user. As a result, the pouch and composition each may undergo complete dispersion within the mouth of the user during normal conditions of use, and hence the pouch and composition both may be ingested by the user. Other examples of pouch materials may be manufactured using water dispersible film forming materials (e.g., binding agents such as alginates, carboxymethylcellulose, xanthan gum, pullulan, and the like), as well as those materials in combination with materials such as ground cellulosics (e.g., fine particle size wood pulp). Preferred pouch materials, though water dispersible or dissolvable, may be designed and manufactured such that under conditions of normal use, a significant amount of the composition contents permeate through the pouch material prior to the time that the pouch undergoes loss of its physical integrity. If desired, flavoring ingredients, disintegration aids, and other desired components, may be incorporated within, or applied to, the pouch material.

Pouches as described herein have three dimensions: a length, a width, and a thickness. One of skill in the art will recognize that such dimensions may vary depending on the intended overall size and volume of the pouch, and the quantity of material desired within the pouch. In some embodiments, each of said length, width, and thickness are in a range from about 0.1 mm to about 40 mm prior to being filled with the composition as disclosed herein.

The amount of material contained within each product unit, for example, a pouch, may vary. In some embodiments, the weight of the composition within each pouch is at least about 50 mg, for example, from about 50 mg to about 2 grams, from about 100 mg to about 1.5 grams, or from about 200 to about 700 mg. In some smaller embodiments, the weight of the composition within each pouch may be from about 100 to about 300 mg. For a larger embodiment, the weight of the material within each pouch may be from about 300 mg to about 700 mg.

In some embodiments, a single compressed tablet, pellet, or agglomerate is placed within a pouch. For example, in some embodiments, a single tablet or agglomerate having a weight of about 700 mg or more is placed within a pouch, the pouch having a volume of about 1.6 cm³ or less. In some embodiments, multiple compressed tablets, pellets, beads, or agglomerates are placed within the pouch, the total weight of the compressed tablets, pellets, beads, or agglomerates being about 700 mg or more, and the pouch having a volume of about 1.6 cm³ or less. It is noted that such tablets, pellets, beads, and agglomerates (or multiple tablets, pellets, beads, or agglomerates) are equally applicable in all sizes and shapes of pouches, e.g., as disclosed herein and as depicted in the associated figures.

In some embodiments, the disclosed pouched products are prepared by a method 50 as generally depicted in FIG. 11. This method generally comprises steps of compressing (52) a powdered material comprising the composition adapted for oral use to give an agglomerate, positioning (54) the agglomerate within a fleece material, welding or sealing (56) the fleece material such that the agglomerate is sealed within the fleece material, cutting (58) into the desired shape, and adding moisture (60) to the pouched product to give a powdered material-containing pouched product.

The compressing step 52 generally involves compressing or compacting a given portion of powdered material comprising the composition adapted for oral use to give an “agglomerate” or “agglomerated material.” Compression or compaction generally comprises application of pressure to the powdered material to be compacted. This compression or compaction can be conducted, for example, within a tablet press/tableting machine or by a molding process. In certain embodiments, a tablet press/tableting machine is employed, which comprises two punches and a compression die; the upper and lower punches come together in the compression die that contains the powdered formulation, thereby compressing the powdered formulation into an agglomerate. Single punch tablet presses and multi-station/rotary tablet presses are known and can be suitably employed in various embodiments.

As referenced above, step 52 generally provides the agglomerate in a form that is sufficiently compressed so as to be a cohesive form, e.g., with sufficient mechanical integrity so as to withstand being ejected from the tablet press or mold and maintain its shape and/or to maintain its shape when placed within a pouch material as described herein below and/or sealed within a pouch material as described herein below (e.g., at all steps prior to step 60). In some embodiments, the agglomerate can be sufficiently compressed so as to withstand extended storage while maintaining its original shape with no significant erosion/degradation. However, in certain embodiments, the agglomerate can be considered to be somewhat “loosely” compressed (so as to later be expanded by the addition of moisture via step 60). The shape, size, and hardness of the agglomerate may vary across a wide range (e.g., as referenced herein above). After production of the agglomerate, the agglomerate can be optionally cleaned, e.g., to ensure no excess non-compressed powder is associated therewith.

At step 54, the agglomerate is positioned within a fleece material. In one embodiment, a first fleece material as described herein can be positioned as a bottom layer, which can optionally include a step of stretching the fleece material to give a stretched bottom layer. The agglomerate can be placed on the bottom layer. While the agglomerate is typically the only component within the pouched products produced according to the disclosed method, the method is not limited thereto and additional components can optionally be added with the agglomerate at this step. A second fleece material as described herein (which can be the same as or different than the first fleece material) can be positioned as a top layer, such that the agglomerate is contained between the first (bottom) and second (top) fleece layers. As noted for the first fleece material, the second fleece material can optionally be stretched to give a stretched top layer.

At step 56, the resulting agglomerate within fleece materials is sealed to give a pouched agglomerate. The method by which the agglomerate is sealed within the pouch can vary and can be any method generally known in the art, e.g., comprising heat sealing. For example, one or more components of the fleece material(s) can comprise a heat sealable binder and/or the method can further comprise spraying or coating a binder onto at least a portion of the fleece material at some point prior to step 56 (as described above). Heat sufficient to bind the fleece materials together is then applied, e.g., around the agglomeration. In certain embodiments, heat is provided by ultrasonic energy as generally known in the art. In some embodiments, the sealing comprises welding to provide seams through the fleece materials around the agglomeration, so as to seal the material therein. The seams may, in some embodiments, be non-perforated seams; in other embodiments, they may be perforated seams. The seams are generally in a shape consistent with the desired final shape of the pouched product (e.g., such as those shapes described herein and/or depicted in the drawings).

An adhesive can be optionally added on a portion of the fleece bottom and/or fleece top to facilitate sealing step 56, e.g., around the agglomerate prior to sealing the top and bottom fleeces (which optional addition can be done before or after step 54). The adhesive, where used, can vary and may be any composition typically used for gluing/adhering two fleece layers together.

The pouched agglomerate is then cut 58 to the desired size/shape (e.g., such as those shapes described herein and/or depicted in the drawings), generally around the welds/seams. Typically, the pouched agglomerate is cut relatively close to the seams. Cutting can be done in various ways, including, but not limited to, manually (e.g., using scissors, knife, or the like), by a punch, or by laser. It is noted that sealing and cutting are described herein as separate steps, but can, in some embodiments, be conducted simultaneously or substantially simultaneously.

In step 60, water is added to the cut pouch to a desired moisture content (i.e., within values as described herein above). The water can be added, e.g., by dosing the cut pouch with water, e.g., by dispensing the water onto one or more surfaces of the cut pouch, such as by spraying. In some embodiments, the addition of water is metered, so as to add a precise amount of water to the cut pouch. Methods and equipment for metering/dosing a precise amount of liquid are known and can include, e.g., dosing pumps.

The addition of moisture advantageously results in the erosion of the agglomerate form, i.e., such that the agglomerated material comprising the composition adapted for oral use takes up at least a portion of the moisture and thereby is provided at least partially in powdered form. As such, the addition of moisture can result in one or more of: the partial or full degradation of the agglomerate within the cut pouch; the partial or full swelling/volume expansion of the agglomerated material within the cut pouch; the partial or full loosening of the agglomerate within the cut pouch; and swelling/expansion of the pouch itself. In some such embodiments, following step 60, the pouched product can be described as comprising a powdered mixture as generally described herein within the pouch.

Various quality control steps can optionally be incorporated within method 50 following the aforementioned steps, e.g., including but not limited to, checking the seams and/or cutting integrity, checking the moisture content, and checking the weight of the final pouched product. In some embodiments, the strength of the final pouched product is measured, e.g., according to Coresta method Number 90 (June 2019), available, at https://www.coresta.org/sites/default/files/technical_documents/main/CRM_90-June2019_0.pdf), which is incorporated herein by reference in its entirety. A non-limiting representative minimum strength is 5 N/mm in the machine and/or cross-direction. Advantageously, pouched products provided via the disclosed method collapse at the fleece instead of at the seal/weld, indicating a sufficiently strong weld. In some embodiments, the result of a quality control evaluation can trigger a further method step. For example, where the weld or cut integrity is not sufficient, the pouched product can be subjected to an additional welding and/or cutting step. Where the moisture content is too low, further water can be added. Where the weight is not within the desired range, the pouch can be broken apart and the powdered material can optionally be recycled for reuse in compression step 52 of the method (with new first and second fleece materials).

If desired, other components can be contained within each pouch. For example, at least one flavored strip, piece or sheet of flavored water dispersible or water soluble material (e.g., a breath-freshening edible film type of material) may be disposed within each pouch along with or without at least one capsule. Such strips or sheets may be folded or crumpled in order to be readily incorporated within the pouch. See, for example, the types of materials and technologies set forth in U.S. Pat. No. 6,887,307 to Scott et al. and U.S. Pat. No. 6,923,981 to Leung et al.; and The EFSA Journal (2004) 85, 1-32; which are incorporated herein by reference.

A pouched product as described herein can be packaged within any suitable inner packaging material and/or outer container. See also, for example, the various types of containers for smokeless types of products that are set forth in U.S. Pat. No. 7,014,039 to Henson et al.; U.S. Pat. No. 7,537,110 to Kutsch et al.; U.S. Pat. No. 7,584,843 to Kutsch et al.; U.S. Pat. No. 8,397,945 to Gelardi et al., D592,956 to Thiellier; D594,154 to Patel et al.; and D625,178 to Bailey et al.; US Pat. Pub. Nos. 2008/0173317 to Robinson et al.; 2009/0014343 to Clark et al.; 2009/0014450 to Bjorkholm; 2009/0250360 to Bellamah et al.; 2009/0266837 to Gelardi et al.; 2009/0223989 to Gelardi; 2009/0230003 to Thiellier; 2010/0084424 to Gelardi; and 2010/0133140 to Bailey et al; 2010/0264157 to Bailey et al.; and 2011/0168712 to Bailey et al. which are incorporated herein by reference.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### EXAMPLES

Aspects of the present invention are more fully illustrated by the following examples, which are set forth to illustrate certain aspects of the present invention and are not to be construed as limiting thereof.

### Example 1. Pouched Product—Compressed Composition; Single Tablet

A pouched product according to an embodiment of the present disclosure is prepared from a dry blend formulation is provided in Table 2, along with optional components (binders, buffers, humectants, flavoring agents, water, and the like). The actual ingredients and percentages can be varied depending on the desired properties of the final product. The dry blend materials are mixed in a blender until homogenous. Following the mixing period, a lubricant (e.g., stearic acid, magnesium stearate, silica, sodium stearyl fumarate, or combinations thereof) is added as necessary for processing, followed by further mixing. Tablets are prepared using a punch or rotary press, forming tablets each having a weight of about 700 mg. The tableted composition is placed into fleece pouches to form the pouched product having a loading density of the composition within the pouch volume of at least about 0.45 g/cm³.

TABLE 2
Exemplary tablet formulation

| Dry Ingredients | Weight % |
|---|---|
| filler | 20-70 |
| active ingredient | 1-10 |
| sweetener | 0.1-0.5 |
| salt | 0.1-3 |
| lubricant | 0-8 |

### Example 2 Pouched Product—Compressed Composition; Multiple Tablets

A pouched product according to an embodiment of the present disclosure is prepared as in Example 1, but with multiple small tablets enclosed in the pouch. The small compressed tablets are prepared using a punch or rotary press, forming tablets having various weights. The compressed tablets are placed into fleece pouches to form the pouched product having a loading density of the composition within the pouch volume of at least about 0.45 g/cm³. The total quantity of composition by weight in each pouch is about 700 mg.

### Example 3. Reference Pouched Product—Particulate Composition (Reference)

A reference pouched product is prepared from a dry blend formulation as provided in Example 1. The dry blend is prepared as in Example 1, and is placed directly into fleece pouches at a loading density of approximately 0.3 g/cm³ to form the pouched product.

### Example 4. Pouched Product—Granulated Composition (Reference)

A reference pouched product is prepared from a dry blend formulation as provided in Example 1. The dry blend is prepared as in Example 1, and the dry blend is contacted with a binder solution in a granulator. Granulation is continued until the desired granule size is obtained. To the granulate, any additional flavorant is added. The composition is placed into fleece pouches to form a pouched product having a loading density of the composition within the pouch volume of approximately 0.3 g/cm³.

### Example 5. Pouched Product—Granulated and Compressed Composition

To the granulated composition of Example 4, prior to placing in the fleece pouch, is added a lubricant (e.g., stearic acid, magnesium stearate, silica, sodium stearyl fumarate, or combinations thereof) as necessary for processing, followed by mixing. Tablets are then prepared using a punch or rotary press, forming tablets having various weights. The tableted composition is placed into fleece pouches to form the pouched product having a loading density of the composition within the pouch volume of at least about 0.45 g/cm³. The quantity of composition by weight in each pouch is about 700 mg, either as a single tablet or as multiple, mini- or micro-tablets.

### Example 6. Pouched Product—Coated Tablets

Tablets prepared according to Example 1 are coated in a pan coater with an aqueous coating solution comprising primarily 10% hydroxypropylmethylcellulose solution with minor amounts of titanium dioxide, sweetener, flavorant, colorant, and PlasACRYL® coating plasticizer. The coated tablets are placed into fleece pouches to form the pouched product, the pouched product having a loading density of the composition within the pouch volume of at least about 0.45 g/cm³.

What is claimed is:

1. A method of preparing a pouched product for oral use, comprising:
compressing a composition for oral use, wherein the composition comprises one or more water-soluble components, to form an agglomerate;
sealing the agglomerate within one or more layers of fleece material and cutting to give a pouched agglomerate; and
adding moisture to the pouched agglomerate in an amount sufficient to at least partially degrade the agglomerate, thereby providing the pouched product.

2. The method of claim 1, wherein the one or more water-soluble components comprise a flavorant.

3. The method of claim 1, wherein the one or more water-soluble components comprise an active ingredient.

4. The method of claim 3, wherein the active ingredient is selected from the group consisting of a nicotinic component, nutraceuticals, botanicals, stimulants, amino acids, vitamins, cannabinoids, cannabamimetics, terpenes, pharmaceutical agents, and combinations thereof.

5. The method of claim 4, wherein the active ingredient is a nicotinic component selected from the group consisting of nicotine, a nicotine salt, or a resin complex of nicotine.

6. The method of claim 1, wherein the compressing comprises placing the composition for oral use within a tablet press.

7. The method of claim 1, wherein the sealing step comprises providing a bottom layer and top layer of fleece material relative to the agglomerate.

8. The method of claim 7, further comprising stretching the bottom layer, the top layer, or both the bottom and top layers.

9. The method of claim 1, wherein the sealing comprises heat sealing.

10. The method of claim 9, wherein the heat sealing is conducted via ultrasonic heating.

11. The method of claim 1, wherein the sealing comprises the formation of a continuous seam through the one or more layers of fleece material and around the agglomerate.

12. The method of claim 1, wherein the cutting comprises using a laser to define and cut an outer boundary of the fleece materials.

13. The method of claim 1, wherein the cutting provides a shape with one or more rounded edges.

14. The method of claim 13, wherein the shape has four or five sides.

15. The method of claim 1, wherein the pouched product has a strength measured according to Coresta method Number 90 (June 2019) of about 5 N/mm in the machine and/or cross-direction.

16. The method of claim 1, wherein the moisture is added via a dosing meter.

17. An oral pouched product prepared according to the method of claim 1.
